(19) United States
(12) Patent Application Publication
(10) Pub. No.: US 2018/0270741 A1
(43) Pub. Date: Sep. 20, 2018

(54) TERMINAL DEVICE, BASE STATION DEVICE, MME, AND COMMUNICATION CONTROL METHOD

(71) Applicant: SHARP KABUSHIKI KAISHA, Sakai City, Osaka (JP)

(72) Inventors: Masayuki ENOMOTO, Sakai City (JP); Masafumi ARAMOTO, Sakai City (JP)

(73) Assignee: SHARP KABUSHIKI KAISHA, Sakai City, Osaka (JP)

(21) Appl. No.: 15/525,659

(22) PCT Filed: Nov. 10, 2015
(86) PCT No.: PCT/JP2015/081541

§ 371 Date: May 10, 2017

(30) Foreign Application Priority Data
Nov. 11, 2014 (JP) 2014-228506

(51) Int. Cl. H04W 48/00; H04W 76/12; H04W 8/08; H04W 36/00; H04W 36/16

(52) U.S. Cl. CPC H04W 48/17; H04W 76/12; H04W 80/04; H04W 36/0022; H04W 36/165; H04W 8/082

(57) ABSTRACT

An MME detects that a PDN connection is not effective and changes a non-optimal gateway as an end point node of the PDN connection to a more optimal gateway. This configuration allows an already-established PDN connection to switch to a new PDN connection using the more optimal gateway, which achieves optimal communication control for continuing communication of UE.

### TECHNICAL FIELD

The present invention relates to a terminal device, a base station device, an MME, and a communication control method.

### BACKGROUND ART

The 3rd Generation Partnership Project (3GPP), which is a group for standardizing mobile communication systems, is advancing the process of formulating specifications for the Evolved Packet System (EPS), which is described in NPL 1 below, as a next-generation mobile communication system.

The following NPL 2 discloses a method for realizing the selected IP traffic offload (SIPTO). SIPTO is the function of providing an offload communication path through which user equipment (UE, terminal device) connects to an eNB (base station device, eNodeB) without the use of the core network of a mobile communication system. In this configuration, the UE establishes an offload communication path for SIPTO with a gateway device that is close in location to the UE.

3GPP has been discussing that, with a local GW (LGW) set as a gateway device used for an offload communication path for SIPTO, UE connecting to an eNB establishes a PDN connection for SIPTO with the LGW, and transmits and receives, via a broadband network, data to and from a device in the network using the PDN connection for SIPTO. At the time of establishing the PDN connection for SIPTO, the UE can establish a communication path with an LGW that is close in location to the UE, which enables communication using an optimal offload communication path.

The UE can continue to communicate while changing eNBs while moving. In this case, the UE maintains the PDN connection for SIPTO established with the LGW and can continue offload communication using the PDN connection.

However, it is assumed that multiple LGWs are provided in a communication system. Therefore, as the UE moves, an LGW closer in location to the UE than an LGW selected at the time of establishing the PDN connection for SIPTO may be present.

An offload communication path provides greater offload effect as the offload is realized by the use of a gateway that is closer in location to the UE. Hence, the PDN connection for SIPTO established by the UE may no longer be an optimal communication path as a result of the move of the UE.

In light of such circumstances, as in NPL 3, 3GPP, which standardizes mobile communication systems, has set, as a requirement, that communication is continued by switching an already-established PDN connection to a new PDN connection using a more optimal gateway device.

### CITATION LIST

### Non Patent Literature

NPL 1: 3GPP TS 23.401 General Packet Radio Service (GPRS) enhancements for Evolved Universal Terrestrial Radio Access Network (E-UTRAN) access
NPL 2: 3GPP TR 23.829 Local IP Access and Selected IP Traffic Offload
NPL 3: 3GPP TR 22.828 Study on Co-ordinated P-GW change for SIPTO

### SUMMARY OF INVENTION

### Technical Problem

However, currently, no concrete means for continuing communication by switching an already-established PDN connection to a new PDN connection using a more optimal gateway device has been introduced.

In addition, it is required that the method for switching a communication path have high seamlessness to minimize disconnection of the communication.

In light of such circumstances, an object of the present invention is to provide a communication system and the like intended to provide optimal communication control for continuing communication of UE by switching an already-established PDN connection to a new PDN connection using a more optimal gateway.

### Solution to Problem

In order to accomplish the object described above, the present invention is contrived to provide the following means.

A terminal device is configured to: establish a first packet data network (PDN) connection with a first gateway device, the first PDN connection being a PDN connection capable of changing a communication path thereof from a communication path to the first gateway device to a communication path to a second gateway device; initiate a service request procedure by transmitting a service request message to a base station device to make a transition from an idle state to an active state; change the communication path of the first PDN connection from the first gateway device to the second gateway device in accordance with the service request procedure; and perform communication using the first PDN connection.

The terminal device is configured to transmit a first access point name (APN) to a core network to establish the first PDN connection. The first APN is an APN associated with permission information permitting a change of the communication path of the first PDN connection from the first gateway device to the second gateway device.

The terminal device is configured to: transmit and receive user data through the first PDN connection using a first IP address; receive a second IP address from the core network in accordance with the service request procedure; change the first IP address to the second IP address; and transmit and receive the user data through the first PDN connection using the second IP address.

The terminal device is configured to: transmit a second APN to the core network to establish a second PDN connection with the first gateway device, the second APN being an APN different from the first APN and an APN not associated with the permission information permitting a change of a communication path of the second PDN connection from the first gateway device to the second gateway device; initiate the service request procedure by transmitting the service request message to the base station device to make a transition from the idle state to the active state; receive a service reject message which is a response to the service request message and rejects the service request; and transmit the second APN to the core network to establish a third PDN connection with the second gateway device in response to the reception of the service reject message.

The first gateway device is a local gateway (LGW) located for offloading, and the second gateway device is a packet data gateway (PGW) located in the core network.

A mobility management entity (MME) is configured to: receive, from a base station device, a service request message transmitted by a terminal device to make a transition from an idle state to an active state, and in a case that the terminal device has established at least a first PDN connection, initiate a control procedure to change a communication path of the first PDN connection from the first gateway device to a second gateway device in accordance with the service request procedure, the first PDN connection being a PDN connection capable of changing the communication path thereof from the communication path to the first gateway device to the communication path to the second gateway device.

The first PDN connection is a PDN connection established using a first access point name (APN), and the first APN is an APN associated with permission information permitting a change of the communication path of the first PDN connection from the first gateway device to the second gateway device.

The MME is configured to: in a case that the terminal device has established at least a second PDN connection, transmit a service reject message in response to the reception of the service request message, the service reject message being a response to the service request message and rejecting the service request; and request the terminal device to initiate an attach procedure by transmitting the service reject message. The second PDN connection is a PDN connection established using the second APN, and the second APN is an APN different from the first APN and an APN not associated with the permission information permitting a change of a communication path of the second PDN connection from the first gateway device to the second gateway device.

The first gateway device is a local gateway (LGW) located for offloading, and the second gateway device is a packet data gateway (PGW) located in the core network.

A base station device is configured to: receive, from a terminal device, a service request message transmitted for making a transition from an idle state to an active state; transmit the service request message to a core network; receive an IP address to be allocated to the terminal device from the core network; and notify the terminal device of the IP address.

A base station device is configured to: receive, from a terminal device, a service request message transmitted for making a transition from an idle state to an active state; transmit the service request message to the core network; receive first identification information from the core network, the first identification information being identification information indicating that the terminal device needs to reacquire an IP address; and notify the terminal device of the first identification information.

A communication control method for a terminal device includes the steps of: establishing a first packet data network (PDN) connection with a first gateway device, the first PDN connection being a PDN connection capable of changing a communication path thereof from a communication path to the first gateway device to a communication path to a second gateway device; initiating a service request procedure by transmitting a service request message to a base station device to make a transition from an idle state to an active state; changing the communication path of the first PDN connection from the first gateway device to the second gateway device in accordance with the service request procedure; and performing communication using the first PDN connection.

The communication control method further includes the step of transmitting a first access point name (APN) to a core network to establish the first PDN connection. The first APN is an APN associated with permission information permitting a change of the communication path of the first PDN connection from the first gateway device to the second gateway device.

The communication control method further includes the steps of: transmitting and receiving user data through the first PDN connection using a first IP address; receiving a second IP address from the core network in accordance with the service procedure; changing the first IP address to the second IP address; and transmitting and receiving the user data through the first PDN connection using the second IP address.

The communication control method further includes the steps of: transmitting a second APN to the core network to establish a second PDN connection with the first gateway device, the second APN being an APN different from the first APN and an APN not associated with the permission information permitting a change of a communication path of the second PDN connection from the first gateway device to the second gateway device; initiating the service request procedure by transmitting a service request message to the base station device to make a transition from the idle state to the active state; receiving a service reject message which is a response to the service request message and rejects the service request; and transmitting the second APN to the core network to establish a third PDN connection with the second gateway device in response to the reception of the service reject message.

The first gateway device is a local gateway (LGW) located for offloading, and the second gateway device is a packet data gateway (PGW) located in the core network.

A communication control method for a mobility management entity (MME) includes the steps of: receiving, from a base station device, a service request message transmitted by a terminal device to make a transition from an idle state to an active state; and in a case that the terminal device has established at least a first PDN connection, initiating a control procedure to change a communication path of the first PDN connection from a first gateway device to a second gateway device in accordance with the service request procedure. The first PDN connection is a PDN connection capable of changing the communication path thereof from the communication path to the first gateway device to the communication path to the second gateway device.

The first PDN connection is a PDN connection established using a first access point name (APN), and the first APN is an APN associated with permission information permitting a change of the communication path of the first PDN connection from the first gateway device to the second gateway device.

The communication control method further includes the steps of: in a case that the terminal device has established at least a second PDN connection, transmitting a service reject message in response to the reception of the service request message, the service reject message being a response to the service request message and rejecting the service request; and requesting the terminal device to initiate an attach procedure by transmitting the service reject message. The second PDN connection is a PDN connection established using the second APN, and the second APN is an APN different from the first APN and an APN not associated with the permission information permitting a change of a communication path of the PDN connection from the first gateway device to the second gateway device.

The first gateway device is a local gateway (LGW) located for offloading, and the second gateway device is a packet data gateway (PGW) located in a core network.

A communication control method for a base station device includes the steps of: receiving, from a terminal device, a service request message transmitted for making a transition from an idle state to an active state; transmitting the service request message to a core network; receiving an IP address to be allocated to the terminal device from the core network; and notifying the terminal device of the IP address.

A communication control method for a base station device includes the steps of: receiving, from a terminal device, a service request message transmitted for making a transition from an idle state to an active state; transmitting the service request message to the core network; receiving first identification information from the core network, the first identification information being identification information indicating that the terminal device needs to reacquire an IP address; and notifying the terminal device of the first identification information.

### Advantageous Effects of Invention

According to the present invention, UE can continue to communicate by switching an already-established PDN connection using a gateway to a new PDN connection using a more optimal gateway.

### BRIEF DESCRIPTION OF DRAWINGS

FIGS. 1A and 1B are diagrams illustrating an overview of a mobile communication system 1 according to a first embodiment.

FIG. 2 is a diagram illustrating a functional configuration of UE according to the embodiment.

FIG. 3 is a diagram illustrating a storage of the UE according to the embodiment.

FIG. 4 is a diagram illustrating a functional configuration of an eNB according to the embodiment.

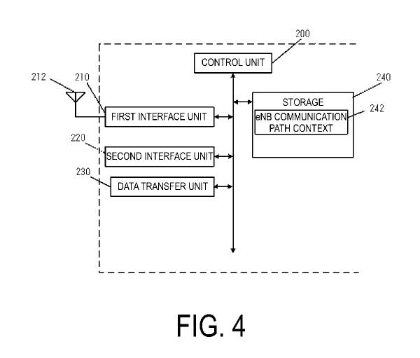

FIG. 5 is a diagram illustrating a storage of the eNB according to the embodiment.

FIG. 6 is a diagram illustrating a functional configuration of an MME according to the embodiment.

FIG. 7 is a diagram illustrating a storage of the MME according to the embodiment.

FIG. 8 is a diagram illustrating a flow of data.

FIG. 9 is a diagram illustrating an attach procedure according to the embodiment.

FIG. 10 is a diagram illustrating a service request procedure according to the embodiment.

FIG. 11 is a diagram illustrating subsequent steps in the service request procedure according to the embodiment.

FIG. 12 is a diagram illustrating subsequent steps in a tracking area update procedure according to the embodiment.

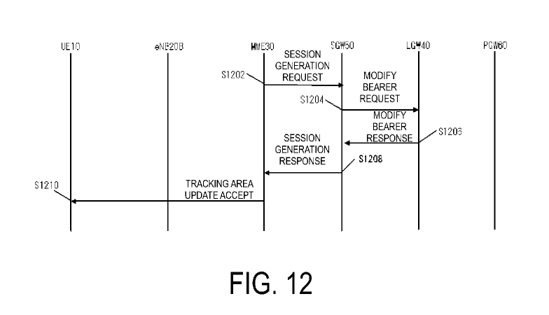

FIG. 13 is a diagram illustrating subsequent steps in a deactivation procedure according to the embodiment.

FIG. 14 is a diagram illustrating a PDN connectivity procedure according to the embodiment.

FIG. 15 is a diagram illustrating a delete session procedure between an LGW and an SGW according to the embodiment.

FIG. 16 is a diagram illustrating a create session procedure 1 according to the embodiment.

FIG. 17 is a diagram illustrating a create session procedure 2 according to the embodiment.

FIGS. 18A to 18C are diagrams illustrating an overview of a mobile communication system 2.

### DESCRIPTION OF EMBODIMENTS

Hereinafter, embodiments for carrying out the present invention will be described with reference to the drawings. Note that for the present embodiment, an embodiment of a mobile communication system to which the present invention is applied will be described in detail as an example, with reference to the drawings.

### 1. First Embodiment

A first embodiment to which the present invention has been applied will be described with reference to the drawings.

### 1.1 Overview of Mobile Communication System

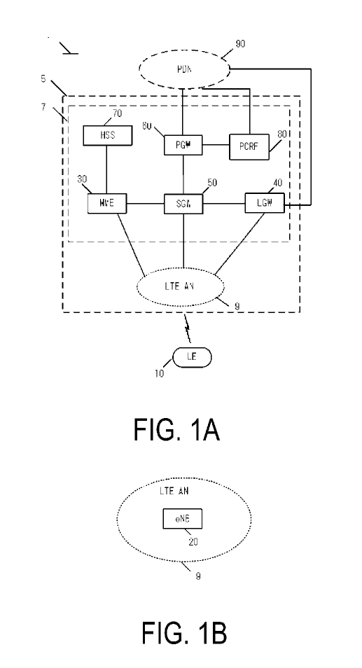

FIGS. 1A and 1B are diagrams illustrating an overview of a mobile communication system 1 according to the present embodiment. As illustrated in FIG. 1A, the mobile communication system 1 is constituted of UE (terminal device) 10 and a packet data network (PDN) 90. The UE 10 and the PDN 90 connect to each other via an IP mobile communication network 5. The UE 10 connects to the IP mobile communication network 5, and the IP mobile communication network 5 is connected with the PDN 90.

The IP mobile communication network 5 may be a network constituted of a radio access network and a core network managed by a mobile network operator, or may be a broadband network managed by a fixed network operator, for example. Here, the broadband network may be an IP communication network that is managed by a network operator and that provides high-speed communication using a digital line such as optical fiber over asymmetric digital subscriber line (ADSL) or the like. Alternatively, the broadband network may be, without being limited to such a network, a network for radio access using worldwide interoperability for microwave access (WiMAX) or the like.

The UE 10 is a communication terminal that establishes a connection using an access system, such as LTE or WLAN. The UE 10 includes a 3GPP LTE communication interface, a WLAN communication interface, or the like and is capable of establishing a connection to an IP access network.

Specifically, the UE 10 is a mobile phone terminal or a smartphone, or a tablet computer, a personal computer, or a home appliance with a communication function.

The PDN 90 is a network that provides network services for transmitting and receiving data in the form of packet. Examples of the PDN 90 include the Internet and IMS. The PDN 90 may be a network that provides group communication services, such as a group call.

The UE 10 connects to the IP mobile communication network to establish a communication path, thereby establishing connectivity with the PDN 90. This configuration allows the UE 10 to transmit and receive data to and from the PDN 90.

The PDN 90 is connected to an IP access network with a wired line or the like. For example, the PDN 90 is constructed by an asymmetric digital subscriber line (ADSL), an optical fiber, or the like. However, the PDN 90 maybe, without being limited to such a configuration, a radio access network such as long term evolution (LTE), wireless LAN (WLAN), or worldwide interoperability for microwave access (WiMAX).

### 1.1.1 Configuration Example of IP Mobile Communication Network

As illustrated in FIGS. 1A and 1B, the mobile communication system 1 is constituted of the UE 10, the IP mobile communication network 5, and the packet data network (PDN) 90.

The IP mobile communication network 5 is constituted of a core network 7 and a radio access network.

The core network 7 is constituted of a mobile management entity (MME) 30, a local gateway (LGW) 40, a serving gateway (SGW) 50, an access control device (PGW: packet data network gateway) 60, a home subscriber server (HSS) 70, and a policy and charging rules function (PCRF) 80.

In the core network 7, multiple MMEs 30, such as an MME 30A and an MME 30B, may be provided.

In the core network 7, multiple SGWs 50, such as an SGW 50A and an SGW 50B, may be provided.

In the core network 7, multiple PGWs 60, such as a PGW 60A and a PGW 60B, may be provided.

In the core network 7, multiple LGWs 40, such as an LGW 40A and an LGW 40B, may be provided. Furthermore, the LGW 40 may be provided within the core network or may be provided within the radio access network 9.

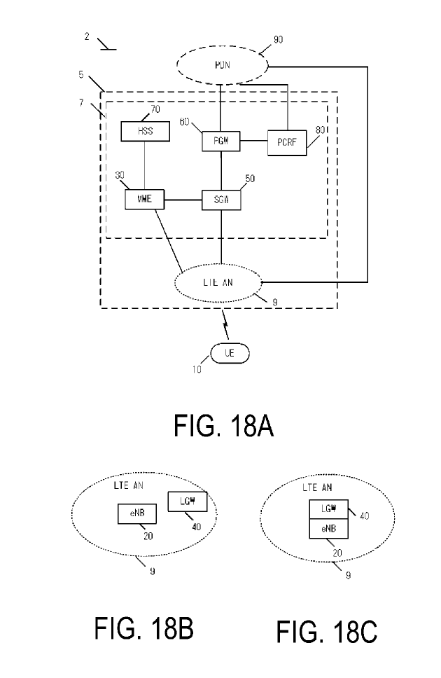

As illustrated in FIGS. 18A, 18B, and 18C, the LGW 40 may be a gateway device provided near the LTE_AN 9 and connecting the LTE_AN 9 to the Internet or a broadband network. The MME 30 may select, depending on a base station device to which the UE 10 connects, an LGW 40 provided near the base station device, as the endpoint node of the PDN connection established by the UE 10.

Here, as illustrated in FIG. 18C, the LGW 40 may be constituted of the same device as an eNB 20. Alternatively, as illustrated in FIG. 18B, the LGW 40 may be constituted of a device separate from the eNB 20.

When no LGW is provided near the base station device, the MME 30 may select the PGW 60 as a gateway device that serves as the endpoint node of the PDN connection established by the UE 10.

Such gateway selection by the MME 30 may be performed on the basis of APN permission information to be transmitted by the UE 10 to establish a PDN connection.

Here, the APN is identification information for selecting a PDN to be connected by the UE 10. Multiple PDNs may be provided. For example, multiple PDNs may be provided for respective services, such as the Internet and a voice call service network (IMS network). Moreover, the UE 10 may store multiple APNs. When the UE 10 notifies the core network of the APN, the MME 30 selects the PDN corresponding to the APN and selects a gateway device to be used for connecting to the PDN.

As described above, the APN is identification information for selecting a PDN to be connected by the UE 10, and may be identification information for selecting a gateway device to be used for connecting to the PDN.

The MME 30 also gives approval to the connection to the PDN and the establishment of the PDN connection on the basis of the APN transmitted to the UE 10. Hence, the APN is identification information that also serves as authentication information for the UE 10 to connect to the PDN or to establish the PDN connection.

The radio access network 9 is connected to the core network 7. Furthermore, the UE 10 can wirelessly connect to the radio access network.

The radio access network may be constituted of an LTE access network 9 (LTE AN) capable of establishing a connection over an LTE access system. The LTE AN 9 is a network including a base station device using the LTE access system. The LTE AN 9 may be a public access network or may be a home network established at home.

Note that each of the devices has a similar configuration to those of existing devices in a mobile communication system using an EPS, which eliminates the need for detailed description thereof. To describe the functions briefly, the PGW 60 is connected to the PDN 90, the SGW 50, and the PCRF 80 and delivers user data by functioning as a gateway device between the PDN 90 and the core network 7.

The SGW 50 is connected to the PGW 60, the MME 30, and the LTE AN 9. The SGW 50 serving as a gateway device between the core network 7 and the LTE AN 9 delivers user data.

The PGW 60 serving as a gateway device connecting the core network 7 and the PDN 90 delivers user data. The PGW 60 establishes a PDN connection with the UE 10 and enables data transmission and reception between the UE 10 and a communication device provided in the PDN 60, with the PDN connection.

The LGW 40 is connected to the SGW 50, the LTE AN 9, and the PDN 90. The LGW 40 serving as a gateway device for the PDN 90 delivers user data. The LGW 40 may be connected to a broadband network and connected to the PDN 90 via the broadband network. As described above, the LGW 40 is a gateway device for establishing a communication path for offloading with the UE 10. In other words, the LGW 40 is an endpoint node of the PDN connection for SIPTO to be established by the UE 10 and is a device that performs offloading on the broadband network and the PDN 90.

The MME 30 is connected to the SGW 50, the LTE AN 9, and the LGW 40 and is a control device that performs location management and access control of the UE 10 via the LTE AN 9.

The HSS 70 is connected to the SGW 50 and an AAA 55 and manages subscriber information.

The PCRF 80 is connected to the PGW 60 and manages QoS management for data delivery.

In addition, as illustrated in FIG. 1B, the radio access network includes devices such as a base station device to which the UE 10 actually connects, and the like. Although various devices adapted to the radio access network are conceivable as the devices used for the connections, the LTE AN 9 is configured to include the eNB 20 in the present embodiment. The eNB 20 is a radio base station to which the UE 10 connects over an LTE access system. The LTE AN 9 may be configured to include one or multiple radio base stations.

Note that, herein, the UE 10 being connected to a radio access network refers to the UE 10 being connected to a base station device included in the radio access network, in which data, signals, and the like being transmitted and received pass through the radio base station device.

For example, the UE 10 being connected to the LTE AN 9 refers to the UE 10 being connected via the eNB 20.

### 1.2 Device Configuration

Next, the configuration of each device will be described briefly with reference to the drawings.

### 1.2.1 Configuration of UE

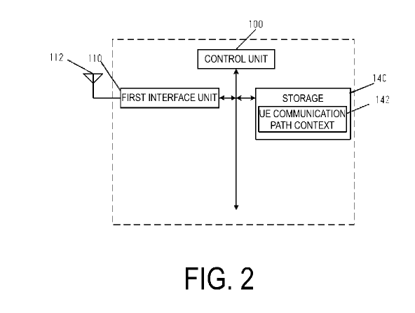

A functional configuration of the UE 10 according to the present embodiment will be described with reference to FIG. 2. In the UE 10, a first interface unit 110 and a storage 140 are connected to a control unit 100 via a bus.

The control unit 100 is a function unit for controlling the UE 10. The control unit 100 implements various processes by reading out various kinds of information and various programs stored in the storage 140 and executing the programs.

The first interface unit 110 is a function unit for establishing a connection to the LTE AN 9 in compliance with an LTE access scheme and transmitting and receiving data using radio communication. An external antenna 112 for transmitting and receiving data in compliance with the LTE access scheme is connected to the first interface unit 110.

The storage 140 is a function unit for storing programs, data, and the like necessary for various operations of the UE 10. The storage 140 is constituted of, for example, a semiconductor memory, a hard disk drive (HDD), or the like. Furthermore, the storage 140 stores a UE communication path context 142.

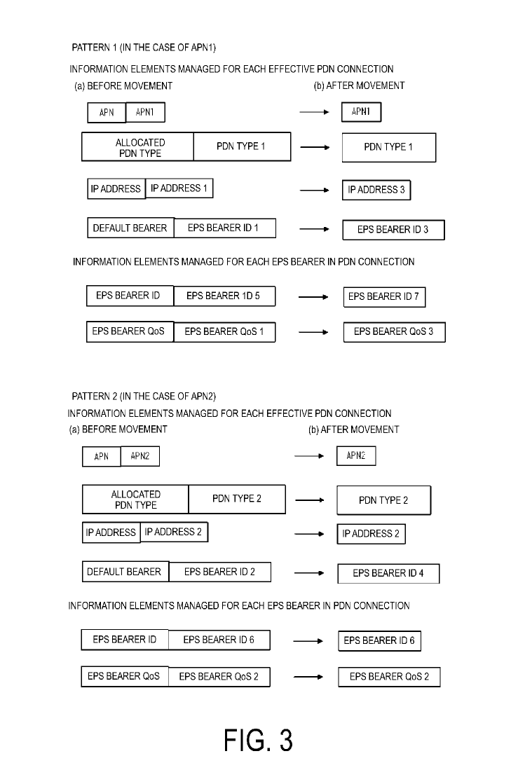

The UE communication path context 142 is a group of information pieces stored in association with a communication path established by the UE. A concrete example of the UE communication path context 142 is illustrated in FIG. 3. FIG. 3 illustrates information elements managed by the UE 10 when the PDN connection has been established with APN1 (pattern 1), and information elements managed by the UE 10 when the PDN connection has been established with APN2 (pattern 2).

As illustrated in FIG. 3, when having established the PDN connection, the UE 10 manages an APN, an allocated PDN type, an IP address, and a default bearer as information elements managed for each effective PDN connection. In addition, when having established the PDN connection, the UE 10 manages an EPS bearer ID and an EPS bearer QoS as information elements managed for each EPS bearer in the PDN connection.

The access point name (APN) is identification information to be used for selection of a gateway device that serves as an endpoint node of the PDN connection to be established by the UE 10 in the IP mobile communication network 5. The APN may be identification information associated with the PDN 90. When a different PDN 90 is configured for each of the services, such as IMS and video streaming, the APN can also be used as identification information identifying the corresponding service. Note that an APN for offload communication that is capable of establishing a SIPTO-enabled PDN connection and an APN that does not perform offload communication may be managed as different APNs. In this case, a gateway selected in accordance with the APN for offloading may be the LGW 40, while a gateway selected in accordance with the APN that does not perform offload communication may be the PGW 60 configured in the core network 7.

Each of the APNs may be associated with permission information for permitting a switch to a PDN connection using a different gateway as an endpoint node.

For example, APN1 may be an APN capable of establishing a PDN connection for SIPTO as well as an APN that is not permitted to switch to a PDN connection using a different gateway as an endpoint node. APN2 may be an APN that is capable of establishing a PDN connection for SIPTO and is permitted to switch to a PDN connection using a different gateway as an endpoint node. APN3 may be an APN that is unable to establish a PDN connection for SIPTO and is not permitted to switch to a PDN connection using a different gateway as an endpoint node. APN4 may be an APN that is unable to establish a PDN connection for SIPTO and is permitted to switch to a PDN connection using a different gateway as an endpoint node.

Note that the UE 10 may hold multiple APNs as described above and establish a PDN connection corresponding to each of the APNs. This configuration allows the UE 10 to establish multiple PDN connections. For example, the UE 10 may establish a PDN connection for offloading using APN1, a PDN connection capable of offloading and a switch to a different gateway using APN2, and a PDN connection for communication via the core network 7 using APN3. Note that APN3 may be an APN that is not permitted to select the LGW 40 as an endpoint node of a PDN connection and that is not permitted to establish an offload communication path. In this case, the UE 10 establishes a PDN connection with the PGW 60 to connect to the PDN.

Here, the PDN connection capable of switching to a different gateway may be a PDN connection capable of switching from the communication path to the first gateway device to the communication path to the second gateway device.

Note that the establishment of a PDN connection using an APN corresponds to the establishment of a PDN connection in accordance with an attach request including at least an APN transmitted by the UE 10 to the MME 30. Note that the UE 10 may transmit, to the MME 30, the APN with the APN included in an attach request message for initiating an attach procedure or may transmit, to the MME, the APN with the APN included in another control message in the attach procedure.

The allocated PDN type is information indicating the version of an IP address allocated to the UE 10. The version of an IP address is either IPv4 or IPv6. Here, the UE 10 is notified of an allocated PDN type together with an IP address in attach accept and manages the notified PDN type as the PDN type to be allocated.

Here, the UE 10 can request the version of the allocated IP address by including the PDN type, which is information indicating the version of IP address, in the attach request.

The IP address is an IP address allocated to the UE 10. The UE 10 transmits uplink data and receives downlink data with the allocated IP address.

The default bearer is information identifying a radio bearer that is a radio communication path established between the UE 10 and the eNB 20 when the UE 10 connects to the eNB 20 in the LTE AN 9.

The default bearer may be an EPS bearer ID, a radio bearer ID, or a linked bearer ID (LBI). Note that the LBI is information associated with a bearer ID.

The UE 10 may manage the APN, the allocated PDN type, the IP address, and the default bearer in association with each other as information elements managed for each of effective PDN connections.

The EPS bearer ID is information identifying a radio bearer that is a radio communication path established between the UE 10 and the eNB 20 when the UE 10 connects to the eNB 20 in the LTE AN 9.

The EPS bearer ID may be a radio bearer ID or a linked bearer ID (LBI). Note that the LBI is information associated with a bearer ID.

The UE 10 may manage, as the default bearer, a bearer ID for a bearer allocated when connecting to the PDN for the first time. Furthermore, the UE 10 may manage, as the EPS bearer ID, a bearer ID when a different bearer is allocated in the same PDN connection.

The EPS bearer QoS is information indicating the quality of service (QoS) associated together with the EPS bearer ID. The EPS bearer QoS is not associated with the default bearer and is information indicating the QoS when an EPS bearer different from the default bearer is allocated in the PDN connection.

The UE 10 may manage the EPS bearer ID and the EPS bearer QoS in association with each other as information elements managed for each EPS bearer in the PDN connection.

The UE 10 may manage the information elements managed for each of effective PDN connections and the information elements managed for each of EPS bearers in the PDN connection in association with each other. In other words, the UE 10 may manage the APN, the allocated PDN type, the IP address, the default bearer, the EPS bearer ID, and the EPS bearer QoS in association with each other.

Note that the UE 10 may establish multiple communication paths. Specifically, the UE 10 may create and manage the UE communication path context 142 for each established PDN connection.

The UE 10 may manage base station identification information and service identification information, in addition to the above-described information.

The base station identification information may be information identifying the eNB 20. The base station identification information may be constituted of a combination of a base station identification code and an operator identification code identifying the mobile network operator providing the communication service. This configuration allows the base station identification information to be unique identification information in multiple mobile communication networks provided by multiple mobile network operators.

The service identification information is information identifying a service provided in the IP communication network 5 by a mobile network operator. The service identification information may be an APN or may be service domain identification information, such as a fully qualified domain name (FQDN). The service identification information may be, without being limited to such information, any identification information associated with the service. Furthermore, the service may include a voice call service or video streaming service based on IMS, and a service providing group communication. The service identification information is identification information identifying such a service.

### 1.2.2 Configuration of eNB

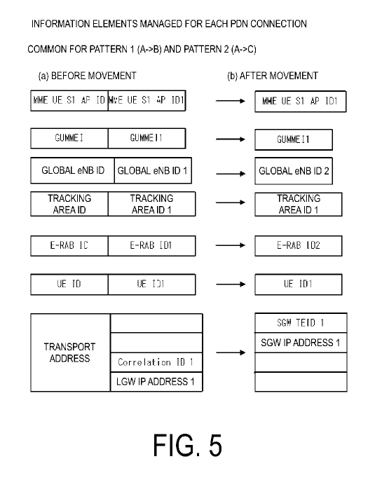

With reference to FIG. 5, a functional configuration of the eNB 20 according to the present embodiment will be described. In the eNB 20, a first interface unit 210, a second interface unit 220, a data transfer unit 230, and a storage 240 are connected to a control unit 200 via a bus.

The control unit 200 is a function unit for controlling the eNB 20. The control unit 200 implements various processes by reading out various kinds of information and various programs stored in the storage 240 and executing the programs.

The first interface unit 210 is a function unit for establishing a radio communication path with the UE 10 in compliance with an LTE access scheme and transmitting and receiving data using radio communication. An external antenna 212 is connected to the first interface unit 210.

The second interface unit 220 is connected to the core network 7 to the core network through wired connection. The connection to the core network 7 may be established over Ethernet (trade name), an optical fiber cable, or the like.

The storage 240 is a function unit for storing programs, data, and the like necessary for various operations of the eNB 20. The storage 240 is constituted of, for example, a semiconductor memory, a hard disk drive (HDD), or the like. Furthermore, the storage 240 stores an eNB communication path context 242.

The eNB communication path context 242 is a group of information pieces stored in association with a communication path established by the eNB 20. FIG. 5 illustrates a concrete example of the eNB communication path context 242. FIG. 5 illustrates information elements managed by the eNB 20 when a PDN connection has been established with APN1 (pattern 1). Note that information elements managed by the eNB 20 when a PDN connection is established with APN2 (pattern 2) have a similar configuration to the information elements illustrated in FIG. 5.

As illustrated in FIG. 5, the eNB 20 manages an MME UE S1 AP ID, a GUMMEI, a global eNB ID, a tracking area ID, an E-RAB ID, a UE ID, and a transport address, as information elements managed for each of effective PDN connections.

The MME UE S1 AP ID is identification information allocated for identifying the UE on the S1 interface. Note that the eNB 20 may receive the MME UE S1 AP ID from the MME 30 and manage the MME UE S1 AP ID. The eNB 20 may receive the MME UE S1 AP ID from the MME 30 by S1-AP signalling.

The GUMMEI is the identification number of the MME 30. The eNB 20 can transfer a message from the UE 10 to the MME 30 with the GUMMEI.

The global eNB ID is identification information identifying the eNB 20. The global eNB ID may be constituted of a combination of an operator identification code identifying the mobile network operator providing the communication service and a base station identification code. This configuration allows the global eNB ID to be unique identification information in multiple mobile communication networks provided by multiple mobile network operators.

The tracking area ID is identification information identifying the tracking area to which the eNB 20 belongs. The tracking area is information indicating the location of the eNB 20.

The E-UTRAN radio access bearer ID (E-RAB ID) is identification information identifying the radio access bearer in the E-UTRAN. When establishing a radio connection with the UE 10, the eNB 20 allocates an E-RAB ID to the UE 10. Note that the E-RAB ID may be a radio bearer ID, an EPS bearer ID, or a default bearer.

The UE ID is identification information identifying a UE. The eNB 20 manages the identification information of the UE 10 that has established a radio connection with the UE 10.

The transport address is information indicating the transfer destination of uplink data from the UE 10. When having established a radio connection with the UE 10, the eNB 20 manages the transfer destination of the uplink data. The transport address may be the IP address of the SGW 50, the TEID for the SGW 50, the IP address of the LGW 40, or the correlation ID or the LHN ID of the LGW 40. The tunnel endpoint ID (TEID) is identification information of a tunnel communication path for transport of user data constituting the PDN connection. The TEID may be identification information of a tunnel communication path established in accordance with a GTP protocol, a mobile IP protocol, or a proxy mobile IP protocol.

The correlation ID is identification information of the tunnel communication path in the LGW 40 corresponding to the TEID in the SGW 50. The correlation ID may be a SIPTO correlation ID specifying that SIPTO is provided. Note that the invention is intended for SIPTO; thus, the correlation ID is a correlation ID providing SIPTO in the present invention unless otherwise stated.

The local HeNB network ID (LHN ID) is identification information identifying the network to which the LGW 40 belongs.

When managing the LGW 40, the eNB 20 may notify the MME 30 of the identification information of the LGW 40 in the attach procedure. When managing the LGW 40, the eNB 20 may notify the MME 30 of the identification information of the LGW 40 in the service request procedure. When managing the LGW 40, the eNB 20 may notify the MME 30 of the identification information of the LGW 40 in the PDN connectivity procedure.

The eNB communication path context 242 may be held for each communication path. For example, when multiple communication paths established with the UE 10 are present, the eNB communication path context 242 may be held for each of the communication paths.

Here, the base station information of the eNB communication path context may hold information identifying the UE 10 and information identifying the eNB 20.

The data transfer unit 230 is a function unit for transferring received data received from the UE 10 via the first interface unit 210, to the IP mobile communication network via the second interface unit 220 and also transferring the received data addressed to the UE 10 received via the second interface unit 220, to the UE 10 via the first interface unit 210.

### 1.2.3 Configuration of MME

The MME 30 is a control device that determines whether or not to give permission regarding establishment of a communication path or provision of a service for the UE 10.

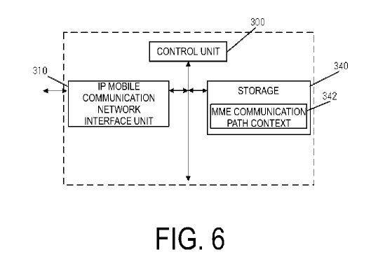

FIG. 6 illustrates a functional configuration of the MME 30. In the MME 30, an IP mobile communication network interface unit 410 and a storage 440 are connected to a control unit 400 via a bus.

The control unit 400 is a function unit for controlling the UE 10. The control unit 400 implements various processes by reading out various programs stored in the storage 440 and executing the programs.

The IP mobile communication network interface unit 410 is a function unit through which the MME 30 connects to the IP mobile communication network 5.

The storage 440 is a function unit for recording programs, data, and the like necessary for various operations of the UE 10. The storage 440 is constituted of, for example, a semiconductor memory, a hard disk drive (HDD), or the like. Furthermore, the storage 440 stores an MME communication path context 442.

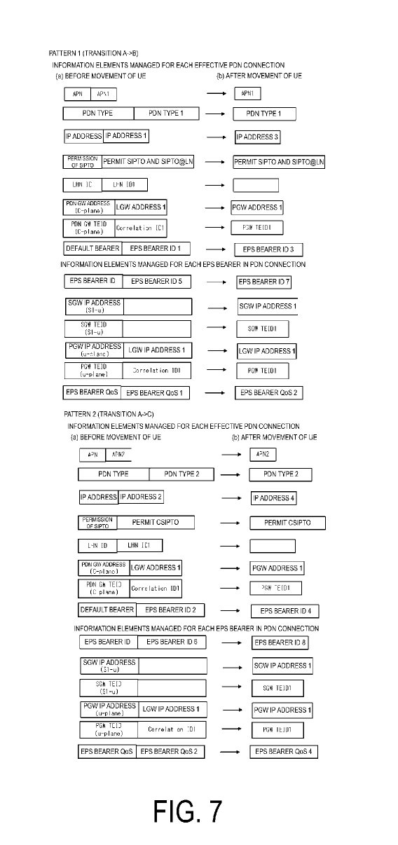

The MME communication path context 442 is a group of information pieces stored in association with a direct communication path established between the UE 10 and the eNB 20. FIG. 7 illustrates a concrete example of the MME communication path context 442. FIG. 7 illustrates the information elements managed by the MME 30 when the PDN connection has been established with APN1 (pattern 1), and the information elements managed by the MME 30 when the PDN connection has been established with APN2 (pattern 2).

As illustrated in FIG. 7, when having established a PDN connection, the UE 10 may manage an APN, a PDN type, an IP address, SIIPTO permission information, a LHN ID, a PDN GW address (C-plane), a PGW TEID (C-plane), a default bearer, and the like as information elements managed for each effective PDN connection.

When the PDN connection has been established, the MME 30 manages an EPS bearer ID, an SGW IP address (S1-u), an SGW TEID (S1-u), a PGW IP address (u-plane), a PGW TEID (u-plane), an EPS bearer QoS, a traffic flow template (TFT), and the like as information elements managed for each EPS bearer in the PDN connection.

The access point name (APN) is identification information to be used for selection of a gateway device that serves as an endpoint node of the PDN connection to be established by the UE 10 in the IP mobile communication network 5. The APN may be identification information associated with the PDN 90. When a different PDN 90 is configured for each of the services, such as IMS and video streaming, the APN can also be used as identification information identifying the corresponding service. Note that an APN for offload communication that is capable of establishing a SIPTO-enabled PDN connection and an APN that does not perform offload communication may be managed as different APNs. In this case, a gateway selected in accordance with the APN for offloading may be the LGW 40, while a gateway selected in accordance with the APN that does not perform offload communication may be the PGW 60 configured in the core network 7.

Each of the APNs may be associated with permission information for permitting a switch to a PDN connection using a different gateway as an endpoint node.

For example, APN1 may be an APN capable of establishing a PDN connection for SIPTO as well as an APN that is not permitted to switch to a PDN connection using a different gateway as an endpoint node. APN2 may be an APN that is capable of establishing a PDN connection for SIPTO and is permitted to switch to a PDN connection using a different gateway as an endpoint node. APN3 may be an APN that is unable to establish a PDN connection for SIPTO and is not permitted to switch to a PDN connection using a different gateway as an endpoint node. APN4 may be an APN that is unable to establish a PDN connection for SIPTO and is permitted to switch to a PDN connection using a different gateway as an endpoint node.

In other words, APN1 may be an APN capable of establishing a PDN connection for SIPTO as well as an APN associated with permission information indicating that a switch to a PDN connection using a different gateway as an endpoint node is not permitted.

Furthermore, APN1 may be an APN capable of establishing a PDN connection for SIPTO as well as an APN not associated with permission information indicating that a switch to a PDN connection using a different gateway as an end point node is permitted.

APN2 may be an APN associated with permission information indicating that a change from a certain gateway device for a communication path of the first PDN connection (or a communication path to a certain gateway device) to a different gateway device (or a communication path to a different gateway device) is permitted.

Furthermore, APN3 may be an APN unable to establish a PDN connection for SIPTO and associated with permission information indicating that a switch to a PDN connection using a different gateway as an end point node is not permitted.

APN4 may be an APN or the like unable to establish a PDN connection for SIPTO and associated with permission information indicating that a switch to a PDN connection using a different gateway as an end point node is permitted.

The MME 30 manages, for each UE, an APN available to the UE. Multiple APNs available to the UE may be provided. For example, the MME 30 may manage that the UE 10 is permitted to establish connections using APN1, APN2, APN3 and APN4.

The PDN type is information indicating the version of the IP address allocated to the UE 10. The version of the IP address is either IPv4 or IPv6. Here, the MME 30 notifies the UE 10 of the PDN type together with the IP address in attach accept and manage the notified PDN type.

The IP address is an IP address allocated to the UE 10. The UE 10 can transmit uplink data and receive downlink data with the allocated IP address.

The MME 30 may manage the IP address of the UE 10 in advance. The MME 30 may manage the IP address notified by the PGW 30. Further, the MME 30 may manage the IP address notified by the LGW 40.

The permission of SIPTO includes information indicating that the associated APN permits SIPTO. Here, the permission information of SIPTO may include, permission information indicating that establishment of a PDN connection for SIPTO is prohibited, permission information indicating that establishment of a PDN connection for SIPTO other than SIPTO@LN is permitted, permission information indicating that establishment of a PDN connection for SIPTO including SIPTO@LN is permitted, or permission information indicating that establishment of a PDN connection only for SIPTO@LN is permitted. Note that, in the present embodiment, the above-described permission information indicating that establishment of a PDN connection for SIPTO including SIPTO@LN is permitted is expressed as permitting SIPTO and SIPTO@LN.

The permission of SIPOTO may include, in addition to the above permission information, permission information indicating that establishment of a PDN connection for SIPTO@LN and SIPTO is possible and a switch to a PDN connection using a different gateway as an endpoint node is permitted. Note that, in the present embodiment, the above-described permission information indicating that establishment of a PDN connection for SIPTO@LN and SIPTO is possible and a switch to a PDN connection using a different gateway as an end point node is permitted is expressed as permission for CSIPTO.

The LHN ID is identification information identifying the network that is managed by the eNB 20 and to which the LGW 40 belongs. The MME 30 may manage the LHN ID when the endpoint node of the gateway in the PDN connection established by the UE 10 is the LGW 40.

The PDN GW address (C-plane) is an IP address for transmitting and receiving control information in the PGW 60. The MME 30 manages the IP address of the LGW 40 and the IP address of the PGW 60 in the PDN GW address (C-plane). Here, the C-plane indicates control information. The PDN GW address (C-plane) is an IP address of the PGW 60 for transmitting and receiving control information. In other words, in the PGW 60, a PGW transmitting and receiving control information and a PGW transmitting and receiving user data may be integrally or separately configured.

The PDN GW TEID (C-plane) is identification information of the tunnel communication path in the PGW 60. The PDN GW TEID is identification information of a tunnel communication path established in accordance with a GTP protocol, a mobile IP protocol, or a proxy mobile IP protocol.

The PDN GW TEID (C-plane) may be a TEID of the PGW 60 for transmitting and receiving control information. In other words, in the PGW 60, the TEID of the PGW transmitting and receiving control information and the TEID of the PGW transmitting and receiving user data may be different from each other.

The PDN GW TEID (C-plane) may include a correlation ID. The correlation ID is identification information of the tunnel communication path in the LGW 40. Note that the correlation ID may be a SIPTO correlation ID specifying that SIPTO is provided.

The default bearer is information identifying a radio bearer that is a radio communication path established between the UE 10 and the eNB 20 when the UE 10 connects to the eNB 20 in the LTE AN 9.

The default bearer may be an EPS bearer ID, a radio bearer ID, or a linked bearer ID (LBI). Note that the LBI is information associated with a bearer ID.

The MME 30 may manage an APN, a PDN type, an IP address, SIP TO permission information, a LHN ID, a PDN GW address (C-plane), a PDN GW TEID (C-plane), and a default bearer in association with each other, as information elements managed for each effective PDN connection.

The EPS bearer ID is information identifying the radio bearer that is the radio communication path established between the UE 10 and the eNB 20 when the UE 10 connects to the eNB 20 in the LTE AN 9.

The EPS bearer ID may be a radio bearer ID or a linked bearer ID (LBI). Note that the LBI is information associated with a bearer ID.

The MME 30 may manage, as the default bearer, the bearer ID of the bearer allocated when connecting to the PDN for the first time, and may manage, when a different bearer is allocated in the same PDN connection, the different bearer as the EPS bearer ID.

The SGW IP address (S1-u) is the IP address of the SGW 50 transmitting and receiving user data. S1-u indicates the interface for transmitting and receiving user data between the SGW 50 and the eNB 20. Note that the SGW 50 transmits and receives user data to and from the eNB 20 but neither transmits nor receives control information to and from the eNB 20.

Note that when the SGW 50 is not included in an established PDN connection, the MME 30 does not need to manage the IP address of the SGW 50.

The SGW TEID (S1-u) is identification information of the tunnel communication path between the eNB 20 and the SGW 50 for transmitting and receiving user data. Note that the SGW 50 transmits and receives user data to and from the eNB 20 but neither transmits nor receives control information to and from the eNB 20.

The SGW TEID (S1-u) may be identification information of a tunnel communication path established in accordance with a GTP protocol, a mobile IP protocol, or a proxy mobile IP protocol. Note that when the SGW 50 is not included in an established PDN connection, the MME 30 does not need to manage the TEID of the SGW 50.

The PGW IP address (U-plane) is the IP address of the PGW 60 transmitting and receiving user data. The MME 30 manages the IP address of the LGW 40 and the IP address of the PGW 60 in the PGW IP address (U-plane). Note that, in the PGW 60, a PGW transmitting and receiving user data and a PGW transmitting and receiving control information may be integrally or separately configured.

The PGW TEID (U-plane) is identification information of the tunnel communication path in the PGW 60 transmitting and receiving user data. The PGW TEID (U-plane) is identification information of a tunnel communication path established in accordance with a GTP protocol, a mobile IP protocol, or a proxy mobile IP protocol. Note that, in the PGW 60, a PGW transmitting and receiving user data and a PGW transmitting and receiving control information may be integrally or separately configured.

Note that the PDN GW TEID (C-plane) may include a PGW TEID and a correlation ID. The correlation ID is identification information of the tunnel communication path in the LGW 40.

Note that the correlation ID may be a SIPTO correlation ID specifying that SIPTO is provided.

The EPS bearer QoS is information indicating the quality of service (QoS) associated together with the EPS bearer ID. The EPS bearer QoS is not associated with the default bearer and is information indicating the QoS when an EPS bearer different from the default bearer is allocated in the PDN connection.

The MME 30 may manage an EPS bearer ID, an SGW IP address (S1-u), an SGW TEID (S1-u), a PGW IP address (U-plane), a PGW TEID (U-plane), and an EPS bearer QoS in association with each other, as information elements managed for each EPS bearer in the PDN connection.

The MME 30 may manage the information elements managed for each effective PDN connection and the information elements managed for each EPS bearers in the PDN connection in association with each other. Specifically, the MME 30 may manage an APN, a PDN type, an IP address, permission of SIPTO, a LHN ID, a PDN GW address (C-plane), a PDN GW TEID (C-plane), a default bearer, an EPS bearer ID, an SGW IP address (S1-u), an SGW TEID (S1-u), a PGW IP address (U-plane), a PGW TEID (U-plane), and an EPS bearer QoS in association with each other.

Note that the MME 30 may establish multiple communication paths. Specifically, the MME 30 may create and manage the MME communication path context 342 for each established PDN connection.

The MME 30 may manage base station identification information and service identification information, in addition to the above-described information.

The base station identification information may be information identifying the eNB 20. The base station identification information may be constituted of a combination of an operator identification code identifying the mobile network operator providing the communication service and the base station identification code. This configuration allows the base station identification information to be unique identification information in multiple mobile communication networks provided by multiple mobile network operators.

The service identification information is information identifying a service provided in the IP communication network 5 by a mobile network operator. The service identification information may be an APN or may be service domain identification information, such as a fully qualified domain name (FQDN). The service identification information may be, without being limited to such information, any identification information associated with the service. Furthermore, the service may include a voice call service or video streaming service based on IMS, and a service providing group communication. The service identification information is identification information identifying such a service.

The MME communication path context 342 may be held for each communication path. For example, when the UE 10 establishes multiple communication paths with the eNB 20, the MME communication path context 342 may be held for each of the communication paths.

### 1.3 Description of Processing

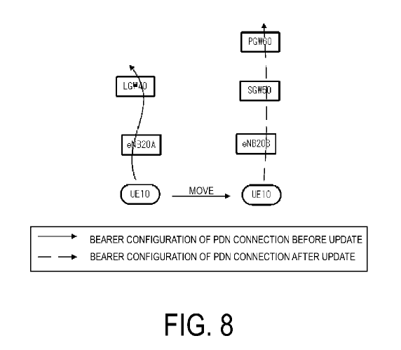

Next, a specific communication path switching method in the above-described mobile communication system will be described. The flow of data in the present embodiment will be described with reference to FIG. 8.

In FIG. 8, first, the UE 10 establishes a first PDN connection and performs data communication with a terminal to communicate with on the network using the first PDN connection.

Here, the first PDN connection may be a PDN connection for offload communication. In other words, the first PDN connection may be a PDN connection for SIPTO established by the UE 10 and the LGW 40 via the eNB 20A.

Note that when the UE 10 is located at least in the serving area of the eNB 20A, the first PDN connection can maintain the PDN connection for which the optimal gateway has been selected.

Next, as the UE 10 moves, the UE 10 changes the serving base station from the eNB 20A to the eNB 20B.

As the UE 10 moves, the serving base station is changed from the eNB 20A to the eNB 20B. In a conventional system, even when the serving base station is changed from the eNB 20A to the eNB 20B, the UE 10 maintains the first PDN connection for which the LGW 40 has been selected, unless the first PDN connection is canceled and a second PDN connection is reestablished. In other words, the UE 10 maintains the first PDN connection to the LGW 40 via the eNB 20B. Here, when the UE 10 is located in the service area of the eNB 20B, the LGW 40 may not necessarily be the optimal gateway for offloading; hence the first PDN connection to the LGW 40 may not be the PDN connection for which the optimal gateway has been selected.

In the present embodiment, even when the UE 10 moves to the eNB 20B, an optimal communication control is performed for the UE to communicate in the core network 7 by switching the already-established first PDN connection to a new second PDN connection that uses the optimal gateway.

Note that in the conventional system, when the MME 30 detects that the already-established first PDN connection is not the optimal communication path, the MME 30 transmits, to the UE 10, a PDN connection reestablishment request for the first PDN connection. Upon receiving the PDN connection reestablishment request from the MME 30, the UE 10 performs a PDN connection reestablishment procedure.

The PDN connection reestablishment procedure by the UE 10 includes a PDN disconnection procedure for disconnecting the already-established first PDN connection and a PDN connectivity procedure for newly establishing the second PDN connection. Note that during the PDN connection reestablishment procedure, the UE 10 cannot transmit or receive user data associated with the PDN connection being re-established.

In the present embodiment, when the MME 30 detects that the already-established first PDN connection is not the optimal communication path, the MME 30 reestablishes the PDN connection in the core network 7 instead of requesting reestablishment of the PDN connection to the UE 10. When detecting that the established first PDN connection is not the optimal communication path, the MME 30 selects the PGW 60 as the optimal gateway in the first PDN connection of the UE 10 and performs the procedure to change the gateway in the first PDN connection.

The MME 30 requests the optimal gateway (PGW 60) selected for the first PDN connection to establish a session. Here, the MME 30 requests the selected optimal gateway (PGW 60) to allocate an IP address.

The MME 30 requests the gateway (LGW 40), which is no longer the optimal gateway in the first PDN connection, to delete the session.

The MME 30 updates the information identifying the optimal gateway (PGW 60) and the IP address received from the optimal gateway (PGW 60) managed in the first PDN connection.

The MME 30 notifies the UE 10 of the IP address received from the optimal gateway (PGW 60). The UE 10 receives the IP address from the MME 30 and updates the IP address managed in the first PDN connection.

The above-described procedure makes it possible to change from the first PDN connection between the UE 10 and the LGW 40, which is no longer the optimal gateway, to the first PDN connection between the UE 10 and the PGW 60, which is the optimal gateway.

Note that even during a reestablishment of an PDN connection in the core network 7, the UE 10 is able to reduce packet loss and the like and delay caused by switching of the communication path without noticing the PDN connection under the reestablishment, which improves seamlessness.

### 1.3.1 Attach Procedure

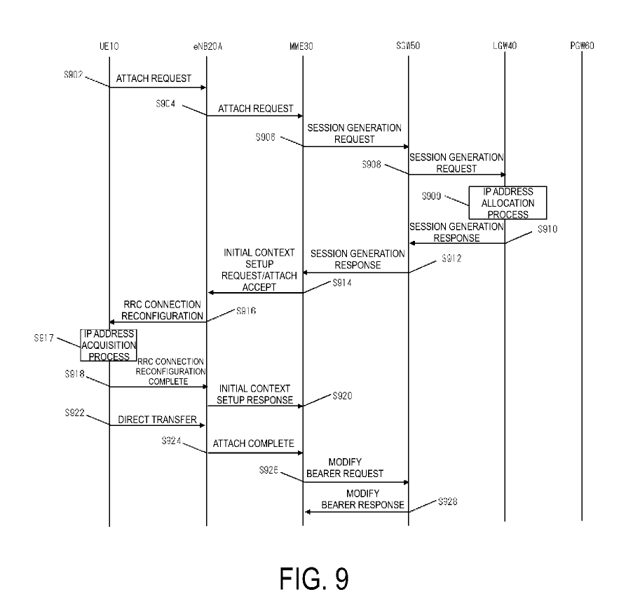

First, an attach procedure in the UE 10 will be described with reference to FIG. 9. Note that the attach procedure allows the UE 10 to establish the second PDN connection with APN2. The UE 10 can transmit and receive data to and from a corresponding node included in the PDN 90 using the second PDN connection.

First, the UE 10 transmits an attach request to the eNB 20A to initiate an attach request procedure (S902). The UE 10 transmits an APN with the APN included in the attach request. The UE 10 may transmit a PDN type with the PDN type included in the attach request to specify the version of the IP address allocated to the UE 10.

For example, the UE 10 may request the establishment of the second PDN connection with APN1 to establish a PDN connection that is a PDN connection for SIPTO and is not permitted to switch to a PDN connection using a different gateway as an end point node.

The UE 10 may establish the first PDN connection with APN1 through the attach procedure. The UE 10 can transmit and receive data to and from a corresponding node included in the PDN 90 using the first PDN connection.

Note that the first PDN connection established with APN1 may be a PDN connection that cannot change the communication path of the first PDN connection from a communication path to a certain gateway device to a communication path to a different gateway device.

APN1 may be an APN capable of establishing a PDN connection for SIPTO and not associated with permission information indicating that a switch to a PDN connection using a different gateway as an end point node is permitted.

The UE 10 may request the establishment of the second PDN connection with APN2 to establish a PDN connection that is a PDN connection for SIPTO and is permitted to switch to a PDN connection using a different gateway as an end point node.

Note that the second PDN connection may be a PDN connection that can change the communication path of the second PDN connection from a communication path to a certain gateway device to a communication path to a different gateway device.

APN2 may be an APN capable of establishing a PDN connection for SIPTO and permitted to switch to a PDN connection using a different gateway as an end point node.

Next, the eNB 20A transmits, to the MME 30, the attach request transmitted by the UE 10 (S904). Here, the eNB 20A may include identification information of a neighboring gateway managed by the eNB 20A, such as the LGW 40, in the attach request transmitted to the MME 30. The eNB 20A may include the LHN ID indicating the network of the LGW 40 in the attach request transmitted to the MME 30.

The eNB 20A may notify the MME 30 of such information in advance, instead of using the attach request.

For example, the eNB 20A may notify the MME 30 of the LHN ID with the LHN ID included in an initial UE message or an uplink NAS transport message, separate from the attach request. The eNB 20A may notify the MME 30 of the information identifying the neighboring gateway, such as the LGW address of the LGW 40, with the information included in the initial UE message or the uplink NAS transport message, separate from the attach request.

The MME 30 receives the attach request from the UE 10 or the eNB 20A. Upon receiving the attach request, the MME 30 detects that the UE 10 is to establish the PDN connection.

Here, the information indicating that the UE 10 is to establish the PDN connection may be the APN included in the attach request. In other words, the MME 30 may detect the establishment on the basis of the APN included in the attach request. The MME 30 may detect establishment of the PDN connection on the basis of the permission information and capability information on the UE 10.

Further, the MME 30 may perform GW selection for establishing the PDN connection in accordance with the APN included in the PDN connectivity request. Here, the GW selection is to select a gateway device serving as an endpoint node of the first PDN connection to be established by the UE 10.

The MME 30 selects a gateway device in the vicinity of the eNB 20A, such as the LGW 40. Further, when having received an APN permitted to establish a PDN connection for SIPTO, such as APN1 or APN2, the MME 30 may select a gateway included in the access network 9.

Note that the MME 30 may select a gateway neighboring on the eNB 20A and establish a PDN connection. The MME 30 may select the gateway neighboring on the eNB 20A in accordance with the LGW address of the LGW 40 notified from the eNB 20A. The MME 30 may select the gateway neighboring on the eNB 20A in accordance with the LHN ID of the LGW 40 notified from the eNB 20A.

The MME 30 may query the HSS 70 to select the gateway. The MME 30 may transmit the APN and the location information to the HSS 70 and receive identification information on the LGW 40 and the like.

The APN may be an APN associated with permission information indicating that a change from a certain gateway device for a communication path of the first PDN connection (or a communication path to a certain gateway device) to a different gateway device (or a communication path to a different gateway device) is permitted.

Next, the MME 30 transmits a session generation request to the SGW 40 (S906). Here, the MME 30 may select, in advance by means of an SGW selection function, the SGW 40 to which the MME 30 transmits the session generation request. In the SGW selection function, the location information on the UE may be used for the selection of the SGW 50. Further, in order to select the SGW 50, an operator policy defined by the mobile network operator may be used.

The MME 30 may include a PGW address, the APN, the PDN type, and the EPS bearer ID in the session generation request.

Here, the PDN GW address may be identification information on the gateway selected by the MME 30 in the GW selection. Specifically, the PDN GW address may include the identification information identifying the LGW 40 and the identification information identifying the PGW 60. Here, the LGW 40 is selected and the PDN GW address includes the identification information identifying the LGW 40.

Description will be given by assuming that the MME 30 includes APN2 as the APN. Note that APN2 may indicate that a new PDN connection is to be established that is a PDN connection for SIPTO and uses a more optimal gateway.

The MME 30 may determine the PDN type on the basis of information on contract with the user of the UE 10, or the like. The MME 30 may authenticate the PDN type included in the attach request transmitted from the UE 10 to determine the PDN type.

The EPS bearer ID may be identification information identifying a bearer allocated to the UE 10 by the MME 30. Note that the EPS bearer ID may be identification information identifying the default bearer.

The SGW 50 transmits a session generation request to the LGW 40 (S908). Here, the SGW 50 may determine the LGW 40 to which the SGW 50 transmits the session generation request on the basis of the identification information on the PDN GW address included in the session generation request transmitted from the MME 30 to the SGW 50. The SGW 50 may include an APN, an SGW address (U-plane), an SGW TEID (U-plane), an SGW TEID (C-plane), a PDN type, and an EPS bearer ID in the session generation request.

For the APN, the PDN type, and the EPS bearer ID, the APN, the PDN type, the PDN address, and the EPS bearer ID included in the session generation request transmitted from the MME 30 may be used, respectively.

The SGW address (U-plane), the SGW TEID (U-plane), and the SGW TEID (C-plane) may be information managed in the SGW 50 in advance.

Upon receiving the session generation request, the LGW 40 performs an IP address allocation process (S909). Here, when the LGW 40 causes a third server device (using DHCP or stateless address configuration) to allocate an IP address, the third server device may provide information indicating the allocation.

The LGW 40 may perform a session establishment procedure. Here, in the session establishment procedure, the LGW 40 may establish a communication path with the default QoS, or may establish a communication path with the EPS bearer QoS different from the default QoS.

The LGW 40 transmits a session generation response to the SGW 50 (S910). The LGW 40 may include a PGW address (U-plane), a PGW TEID (U-plane), a PGW TEID (C-plane), a PDN type, a PDN address, an EPS bearer ID, and an EPS bearer QoS in the session generation response.

The PGW address (U-plane), the PGW TEID (U-plane), and the PGW TEID (C-plane) may be information managed in the LGW 40 in advance. Here, the PGW address (U-plane) may be identification, information identifying the LGW 40. Each of the PGW TEID (U-plane) and the PGW TEID (C-plane) may be a correlation ID. The correlation ID is identification information on the tunnel communication path in the LGW 40. Note that the correlation ID may be a SIPTO correlation ID specifying that SIPTO is provided.

The PDN type may be the PDN type included in the session generation request (S908) transmitted from the SGW 50.

The PDN address may be an IP address allocated to the UE 10 by the LGW 40. Here, when the allocation of the IP address is performed by the third server device, the third server device may include information indicating the allocation.

The EPS bearer ID and the EPS bearer QoS may be information elements relating to a case of establishing QoS different from the default bearer.

Further, the SGW 50 transmits a session generation response to the MME 30 (S912). Here, the SGW 50 may include a PDN type, a PDN address, an SGW address (U-plane), an SGW TEID (U-plane), an SGW TEID (C-plane), an EPS bearer ID, an EPS bearer QoS, a PGW address (U-plane), and a PGW TEID in the session generation response.

Here, the PDN type, the PDN address, the EPS bearer ID, the EPS bearer QoS, the PGW address (U-plane), and the PGW TEID may be information elements included in the session generation request (S910) transmitted from the LGW 40.

The SGW address (U-plane), the SGW TEID (U-plane), and the SGW TEID (C-plane) may be information elements managed by the SGW 50.

The MME 30 receives the session generation response. The MME 30 may manage the PDN type, the PDN address, the SGW address (U-plane), the SGW TEID (U-plane), the SGW TEID (C-plane), the EPS bearer ID, the EPS bearer QoS, the PGW address (U-plane), and the PGW TEID included in the session generation response, together with the APN, the SIPTO permission information, and the LHN ID.

The MME 30 can manage information elements managed for each effective PDN connection before movement of the UE in the MME communication path context 342 illustrated in FIG. 7 and information elements managed for each EPS bearer in the PDN connection.

As described above, the MME 30 can manage information on the first PDN connection.

Next, the MME 30 transmits an initial context setup request/attach accept to the eNB 20A (S914).

Note that the MME 30 provides information on the first PDN connection to be newly established, with the information included in the initial context setup request or the attach accept.

The attach accept may include the APN, the PDN type, the PDN address, the EPS bearer ID, and the EPS bearer QoS.

The initial context setup request may include the EPS bearer QoS, the EPS bearer ID, the SGW TEID (U-plane), and the SGW address (U-plane). When a PDN connection using an LGW as an end point node (a PDN connection for SIPTO@LN) is established, the initial context request may include a SIPTO correlation ID.

The eNB 20B receives the initial context setup request/attach accept. The eNB 20A determines establishment of a radio bearer with the UE 10 on the basis of the EPS bearer ID and the EPS bearer QoS included in a modify bearer request. Here, the eNB 20A may determine the E-RAB ID on the basis of the EPS bearer ID and the EPS bearer QoS.

The eNB 20B may manage the SGW TEID (U-plane), the SGW address (U-plane), and the SIPTO correlation ID included in the modify bearer request.

As described above, the eNB 20A can manage the information elements in the eNB communication path context 242, illustrated in (a) before movement of FIG. 5.

Next, the eNB 20A transmits an RRC connection reconfiguration to the UE 10 (S916). Note that the eNB 20A includes the attach accept in the RRC connection reconfiguration notification destined to the UE 10. Here, the eNB 20 may include the attach accept, separate from the RRC connection reconfiguration notification destined to the UE 10. In other words, the eNB 20 transfers the attach accept to provide information on the newly established first PDN connection.

The UE 10 receives the RRC connection reconfiguration and the attach accept from the eNB 20A. Here, the UE 10 detects information on the newly established first PDN connection included in the attach accept transferred from the eNB 20A, and manages the information therein.

Note that the information on the first PDN connection may be the APN, the PDN type, the PDN address, the EPS bearer ID, and the EPS bearer QoS.

Next, the UE 10 performs an IP address acquisition process (S917). Here, the UE 10 may acquire the PDN address included in the attach accept as an IP address.

When the PDN address included in the attach accept includes information indicating acquisition of an IP address in accordance with DHCP, the UE 10 may acquire the IP address from the DHCP server. Here, the DHCP server may be an external server outside the core network 7, or may be the LGW 40.

When the PDN address included in the attach accept includes information indicating acquisition of an IP address in accordance with the stateless address auto-configuration, the UE 10 may receive a router advertisement (RA) from a router device and acquire the IP address on the basis of the router advertisement. Here, the router device may be an external server outside the core network 7, or may be the LGW 40.

The UE 10 acquires the IP address by the above method and manages the IP address as the first PDN connection therein. The UE 10 can manage the information on the first PDN connection in the UE communication path context 142 illustrated in (a) before movement of FIG. 3, and can transmit the uplink data in the first PDN connection.

The UE 10 transmits an RRC connection reconfiguration complete (S918). The eNB 20A receives the RRC connection reconfiguration complete as a response to the RRC connection reconfiguration (S916), and transmits an initial context setup response to the MME 30 (S920).

The UE 10 transmits a direct transfer to the eNB 20A (S922). Here, an attach complete may be included in the direct transfer. The EPS bearer ID may be included in the attach complete.

The eNB 20A receives the direct transfer from the UE 10 and transfers the attach complete included in the direct transfer to the MME 30 (S924). The MME 30 that has received the initial context setup response and the attach complete transmits a modify bearer request to the SGW 50 (S926). The SGW 50 receives the modify bearer request from the MME 30 and transmits a modify bearer response to the MME 30 (S928).

The above-described procedure allows the first PDN connection to be established between the UE 10 and the LGW 40. In other words, the UE 10 can transmit the APN to the core network 7 to establish the first PDN connection.

The UE 10 can manage, as information on the first PDN connection, the APN, the allocated PDN type, the IP address, the default bearer, the EPS bearer ID, and the EPS bearer QoS, in the UE communication path context 142 illustrated in (a) before movement of FIG. 3.

The eNB 20A can manage, as information on the first PDN connection, the MME UE S1 AP ID, the GUMMEI, the global eNB ID, the tracking area ID, the E-RAB ID, the UE ID, and the transport address, in the eNB communication path context 242 illustrated in FIG. 5.

Further, the MME 30 can manage, as information on the first PDN connection, the APN, the PDN type, the IP address, the permission (information) of SIPTO, the LHN ID, the PDN GW address (C-plane), the PDN GW TEID (C-plane), the default bearer, the EPS bearer ID, the SGW IP address (S1-u), the SGW TEID (S1-u), the PGW IP address (U-plane), the PGW TEID (U-plane), and the EPS bearer QoS, in the MME communication path context 342 illustrated in FIG. 7.

As described above, the UE 10 can transmit and receive data via the LGW 40 using the first PDN connection. Note that the first PDN connection is a PDN connection capable of changing the communication path of the first PDN connection from a communication path to a certain gateway device to a communication path to a different gateway device.

Note that, when the UE 10 includes APN2 in the attach request (S902) as an APN and completes the attach procedure to establish the first PDN connection, the UE 10 manages APN2 as the APN, PDN type 2 as the allocated PDN type, IP address 2 as the IP address, EPS bearer ID 2 as the default bearer, EPS bearer ID 6 as the EPS bearer ID, and EPS bearer QoS 2 as the EPS bearer QoS, as illustrated in the UE communication path context 142 in pattern 2 (a) before movement of FIG. 3.

In this case, the eNB 20 manages MME UE S1 AP ID 1 as the MME UE S1 AP ID, GUMMEI 1 as the GUMMEI, global eNB ID 1, tracking area ID 1 as the tracking area ID, E-RAB ID 1 as the E-RAB ID, UE ID 1 as the UE ID, and correlation ID 1 and LGW IP address 1 as the transport address, as illustrated in the eNB communication path context 242 in FIG. 5.

The MME 30 manages APN2 as the APN, PDN type 2 as the PDN type, IP address 2 as the IP address, permission of CSIPTO as the permission of SIPTO, LHN ID 1 as the LHN ID, LGW address 1 as the PDN GW address (C-plane), correlation ID 1 as the PDN GW TEID (C-plane), EPS bearer ID 2 as the default bearer, EPS bearer ID 6 as the EPS bearer ID, LGW IP address 1 as the PGW IP address (U-plane), correlation ID 1 as the PGW TEID (U-plane), and EPS bearer QoS 2 as the EPS bearer QoS, as indicated in the MME communication path context 342 in FIG. 7.

When the UE 10 includes APN1 in the attach request (S902) as an APN and completes the attach procedure to establish the first PDN connection, the UE 10 manages APN1 as the APN, PDN type 1 as the allocated PDN type, IP address 1 as the IP address, EPS bearer ID 1 as the default bearer, EPS bearer ID 5 as the EPS bearer ID, and EPS bearer QoS 1 as the EPS bearer QoS, as illustrated in the UE communication path context 142 in pattern 1 (a) before movement of FIG. 3.

In this case, the eNB 20 manages MME UE S1 AP ID 1 as the MME UE S1 AP ID, GUMMEI 1 as the GUMMEI, global eNB ID 1 as the global eNB ID, tracking area ID 1 as the tracking area ID, E-RAB ID 1 as the E-RAB ID, UE ID 1 as the UE ID, and correlation ID 1 and LGW IP address 1 as the transport address, as illustrated in the eNB communication path context 242 in FIG. 5.

The MME 30 manages APN1 as the APN, PDN type 1 as the PDN type, IP address 1 as the IP address, permission of SIPTO and SIPTO@LN as the permission of SIPTO, LHN ID 1 as the LHN ID, LGW address 1 as the PDN GW address (C-plane), correlation ID 1 as the PDN GW TEID (C-plane), EPS bearer ID 1 as the default bearer, EPS bearer ID 5 as the EPS bearer ID, LGW IP address 1 as the PGW IP address (U-plane), correlation ID 1 as the PGW TEID (U-plane), and EPS bearer QoS 1 as the EPS bearer QoS, as illustrated in the MME communication path context 342 in FIG. 7.

### 1.3.2 Service Request Procedure

Next, the UE 10 performs a service request procedure to resume transmission and reception of data using the first PDN connection established by the UE 10 and the LGW 40 in the attach procedure. Here, the UE 10 changes a state thereof from a connected state to an idle state when data transmission and reception is completed in the first PDN connection. When performing the service request procedure, the UE 10 changes the state thereof from the idle state to the connected state, which allows the UE 10 to initiate transmission and reception of data in the first PDN connection. Here, the UE 10 may transmit, in order to change the state thereof from the idle state to the connected state, a service request message to the base station device to initiate the service request procedure.

Note that, in the present invention, data transmission and reception is not initiated using the first PDN connection by the service request procedure, but data transmission and reception is started by detecting that the first PDN connection is a PDN connection between the UE 10 and the LGW 40, which is no longer the optimal gateway, and changing the first PDN connection to the UE 10 and the PGW 60 which is the optimal gateway.

According to the present invention, after the first PDN connection is disconnected, the first PDN connection is changed to the optimal gateway rather than that the second PDN connection is established.

The present invention enables selection between disconnecting the first PDN connection and then establishing the second PDN connection, and changing the first PDN connection to the first PDN connection to the optimal gateway.

Here, the UE 10 may be a tracking area update procedure rather than a service request procedure.

Note that the tracking area update procedure is a procedure for updating the location of the UE 10 to the core network 7, rather than initiating transmission and reception of data in the first PDN connection.

As with the service request procedure, the tracking area update procedure can detect that the first PDN connection is a PDN connection between the UE 10 and the LGW 40 which is no longer the optimal gateway, and change the first PDN connection to the UE 10 and the PGW 60 which is the optimal gateway.

As with the service request procedure, the tracking area update procedure can change the first PDN connection to the optimal gateway, without disconnecting the first PDN connection and then establishing the second PDN connection.

As with the service request procedure, the tracking area update procedure enables selection between disconnecting the first PDN connection and then establishing the second PDN connection, and changing the first PDN connection to the first PDN connection to the optimal gateway.

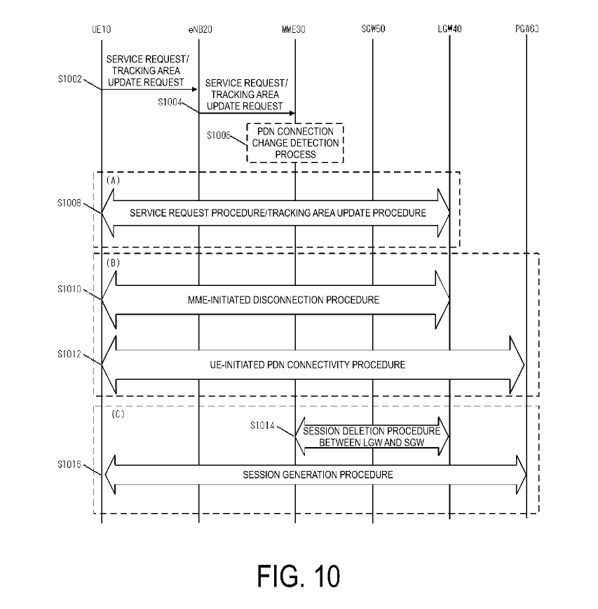

With reference to FIG. 10, the service request procedure in the UE 10 will be described.

First, the UE 10 transmits a service request to the eNB 20 (S1002). Here, the UE 10 may transmit the service request with the service request included in the RRC message to be transmitted to the eNB 20. Note that the service request (S1002) transmitted by the UE 10 may be a tracking area update request. Here, the tracking area update request may include information indicating the location of the UE. Here, the information indicating the location of the UE may be a tracking area ID.

Next, the eNB 20 receives the service request and transfers the service request to the MME 30 which is a device in the core network 7 (S1004). Here, the eNB 20 may transmit the service request with the service request included in the initial UE message to be transmitted to the MME 30. The initial UE message may include a SIPTO LGW transport address and the LHN ID managed by the eNB 20. Here, when the eNB 20 does not manage the LGW 40, the initial UE message need not include the SIPTO LGW transport address (the LGW address of the LGW 40) or the LHN ID.

Note that the service request (S1004) transmitted by the eNB 20 may be a tracking area update request. Here, the tracking area update request may include information indicating the location of the UE.

The MME 30 receives the service request from the UE 10 or the eNB 20. Here, the MME 30 performs a PDN connection change detection process (S1006). Here, on the basis of the service request transmitted from the UE 10, the MME 30 determines whether to continue the service request procedure.

Here, the MME 30 may determine whether to continue the service request procedure by detecting that the first PDN connection is effective.

The MME 30 may receive the tracking area update request instead of the service request from the eNB 20, and perform the PDN connection change detection process. The MME 30 may determine whether to continue the tracking area update procedure by detecting that the first PDN connection is effective.

Here, the first PDN connection being effective may be detected on the basis of the UE 10 not having changed the base station device to which the UE 10 is connected, or the LGW 40 being the optimal gateway device for the offload even when the UE 10 has changed the base station device to which the UE 10 is connected.

More specifically, whether the first PDN connection is effective may be detected on the basis of the LHN ID and the SIPTO LGW transport address (the LGW address of the LGW 40) included in the initial UE message transmitted from the eNB 20B.

The MME 30 may detect the effectiveness by the LHN ID managed in the MME communication path context 342 managed by the MME 30, or by the LGW IP address in the PGW IP address (U-plane).

The MME 30 may compare the LEN ID and the SIPTO LGW transport address (the LGW address of the LGW 40) included in the initial UE message transmitted from the eNB 20, with the LHN ID managed in the MME communication path context 342 and the LGW IP address in the PGW IP address (U-plane), to detect that the first PDN connection is effective.

When detecting that the first PDN connection is effective, the MME 30 may continue the service request procedure (S1008). Here, the MME 30 may determine to continue the tracking area update procedure.

Here, when not detecting that the first PDN connection is effective, the MME 30 may determine to perform a disconnection procedure on the first PDN connection or perform a change procedure on the first PDN connection. For example, the MME 30 may detect that the first PDN connection is not effective, on the basis of factors such as when it is detected that the LGW 40 is no longer the optimal gateway for offloading, when an optimal gateway device other than the LGW 40 is detected, or when the base station device to which the UE 10 is connected is not permitted to establish a PDN connection for SIPTO using the LGW as an end point node.

Further, the determination whether the MME 30 performs the disconnection procedure on the first PDN connection or performs the change procedure on the first PDN connection may be made depending on the PDN connection. More specifically, the determination may be made on the basis of the APN permission information used for the establishment of the PDN connection. More specifically, the determination may be made on the basis of the permission of SIPTO associated with the APN managed in the MME communication path context 342.

For example, when the APN managed in the MME communication path context 342 is APN1 and permission of SIPTO includes information indicating permission of SIPTO and SIPTO@LN, the MME 30 may determine to perform the disconnection procedure on the first PDN connection. In this manner, the disconnection procedure may be performed when the first PDN connection is a PDN connection established using APN1.

Alternatively, the disconnection procedure on the first PDN connection may be performed on the basis of the determination made by a network operator, such as the policy of the operator, irrespective of the APN used when the first PDN connection is established. For example, when multiple PDN connections established by the UE 10 are present, the network operator may determine in advance whether to perform a disconnection procedure or to perform a switch procedure on each of the PDN connections.

When the disconnection procedure on the first PDN connection is to be performed, the MME 30 may initiate the disconnection procedure (S1010).

Note that, in the MME-initiated disconnection procedure, the MME 30 may include information indicating that the first PDN connection is to be reestablished to the UE 10. In the MME-initiated disconnection procedure, when detecting information indicating that the first PDN connection is to be reestablished from the MME 30, the UE 10 may initiate a PDN connection establishment procedure through the UE-initiated PDN connectivity procedure (S1012).

On the other hand, when the APN managed in the MME communication path context 342 is APN2 and permission of SIPTO includes information indicating permission of CSIPTO, the MME 30 may determine to perform the change procedure on the first PDN connection. In this manner, the PDN connection change procedure may be performed when the first PDN connection is a PDN connection established using APN2. Details of the PDN connection change procedure will be described below.

Alternatively, the change procedure on the first PDN connection may be performed on the basis of the determination made by the network operator, such as the policy of the operator, irrespective of the APN used for the establishment of the first PDN connection. For example, when multiple PDN connections established by the UE 10 are present, the network operator may determine in advance whether to perform the change procedure or to perform a switch procedure on each of the PDN connections.

When performing the change procedure on the first PDN connection, the MME 30 may determine to perform the delete session procedure between the LGW and the SGW (S1014) and the create session procedure (S1016).

In other words, the control procedure for changing the communication path of the first PDN connection from a certain gateway device (or a communication path to a certain gateway device) to a different gateway device (or a communication path to a different gateway device) may be initiated.

Note that in the following description, an example in which the create session procedure is performed after the delete session procedure will be described, but the order may be changed. In other words, the delete session procedure may be performed after the create session procedure. When the delete session procedure is performed after performing the create session procedure, a switching with shorter delay is available since the session as a switching destination is in the established state at the time of session deletion. Note that even when the order is reversed, specific contents of each procedure may be the same.

### 1.3.2.1.1 Continuation of Service Request Procedure

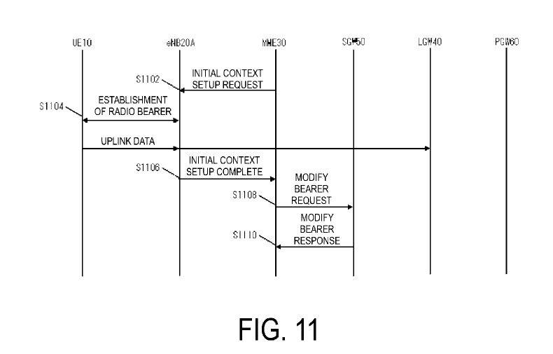

A case in which the MME 30 detects that the first PDN connection is effective and has determined to continue the service request procedure in the PDN connection change detection process (S1006) will be described. The subsequent steps of the conventional service request procedure will be described with reference to FIG. 11. Note that a case in which the MME 30 determines to perform the tracking area update procedure instead of the service request procedure will be described later.

FIG. 11 illustrates the procedure for the UE 10 to continue the service request procedure when the UE 10 does not move from the eNB 20A for which the attach procedure has been performed, but even when moving to another eNB 20, the UE 10 may initiate the service request procedure as long as the first PDN connection is effective.

The procedure for continuing the service request procedure enables transmission and reception of user data in the first PDN connection.

Upon detecting that the first PDN connection is effective, the MME 30 transmits an initial context setup request to the eNB 20A (S1102). The initial setup configuration request may include the SGW address, the SGW TEID, the EPS bearer QoS, and the SIPTO correlation ID.

The eNB 20A receives the initial context setup request. The eNB 20A may manage the SGW address, the SGW TEID, the EPS bearer QoS, and the SIPTO correlation ID included in the initial setup configuration request.

Next, the eNB 20A establishes a radio bearer with the UE 10 (S1104). The eNB 20A may establish a radio bearer on the basis of the EPS bearer QoS. The eNB 20A may create radio parameters for establishing the radio bearer on the basis of the EPS bearer QoS.

The UE 10 that has established the radio bearer transmits the uplink data to the eNB 20A. Note that the eNB 20A transfers, to the LGW 40, the uplink data transmitted from the UE 10. The LGW 40 transfers, to the PDN 90, the uplink data transmitted from the eNB 20.

The eNB 20A that has established the radio bearer transmits an initial context setup complete to the MME 30. The initial context setup complete may include the eNB address, a list of accepted EPS bearers, a list of rejected EPS bearers, and the SGW TEID. Here, the eNB 20A may include identification information identifying at least the first PDN connection in the list of accepted EPS bearers.

The MME 30 receives the initial context setup complete from the eNB 20A. Here, when the list of rejected EPS bearers is included, the MME 30 may delete information on the corresponding PDN connection.

Next, the MME 30 transmits a modify bearer request (S1106). The MME 30 may include the eNB address and an S1 TEID in the modify bearer request. Note that the eNB address and S1 TEID included in the modify bearer request may be information elements by which the MME 30 is associated with the first PDN connection.

The SGW 50 receives the modify bearer request from the MME 30. The SGW 50 can transmit downlink data addressed to the UE 10 in the first PDN connection associated with the eNB address and the S1 TEID corresponding to the eNB address and S1 TEID included in the modify bearer request.

The SGW 50 transmits a modify bearer response as a response to the modify bearer request to the MME 30 (S1110).

The above-described service request procedure allows data to be transmitted and received in the first PDN connection between the UE 10 and the LGW 40.

### 1.3.2.1.2 Continuation of Tracking Area Procedure

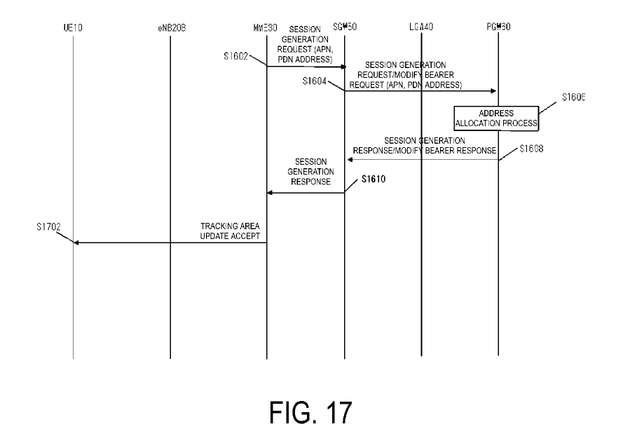

A case in which the MME 30 detects that the first PDN connection is effective and has determined to continue the tracking area update procedure in the PDN connection change detection process (S1006) will be described. The subsequent steps of the conventional service request procedure will be described with reference to FIG. 17.

FIG. 17 illustrates the procedure for the UE 10 to continue the tracking area procedure when the UE 10 does not move from the eNB 20A for which the attach procedure has been performed, but even when moving to another eNB 20, the UE 10 may initiate the service request procedure as long as the first PDN connection is effective.

Upon detecting that the first PDN connection is effective, the MME 30 transmits a tracking area update accept to the UE 10 (S1210). The tracking area update accept may include information indicating the location of the UE.

Note that even when detecting that the first PDN connection is effective, the MME 30 may transmit a session generation request (1202) to the SGW 50 before transmitting the tracking area update accept. The SGW 50 may transmit a modify bearer request to the LGW 40. The LGW 40 may transmit a modify bearer response to the SGW 50 (S1206). The SGW 50 may transmit a session generation response to the MME 30 (S1208).

The above-described tracking area update procedure allows the first PDN connection to be maintained between the UE 10 and the LGW 40.

### 1.3.2.2 PDN Connection Disconnection Procedure and Establishment Procedure

A conventional procedure for a case in which the MME 30 does not determine to continue the service request procedure in the first PDN connection and has determined to disconnect the PDN connection in the modify bearer detection process (S1006) will be described. Note that when the MME 30 has determined to disconnect the PDN connection, the MME-initiated disconnection procedure is performed. The MME 30 may notify the UE 10 of information indicating that the PDN connection is to be reestablished during the MME-initiated disconnection procedure. When receiving the information indicating that the PDN connection is to be reestablished from the MME 30, the UE 10 may initiate the UE-initiated PDN connectivity procedure.

### 1.3.2.2.1 MME-Initiated Disconnection Procedure

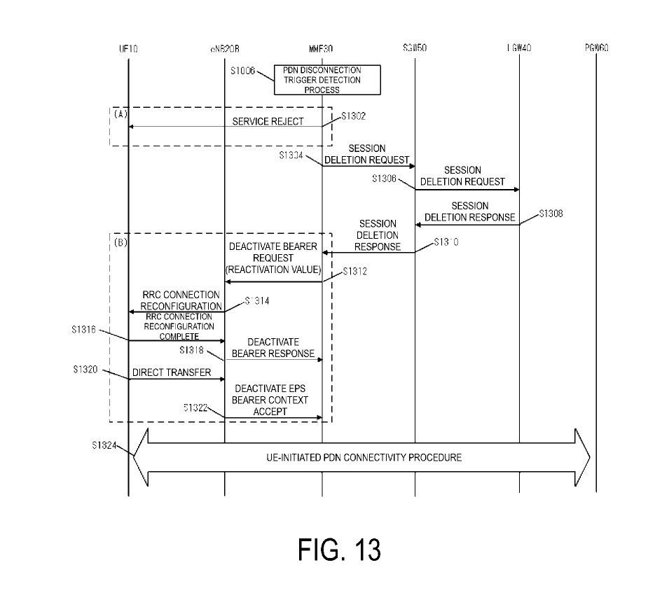

The MME-initiated disconnection procedure will be described with reference to FIG. 13. The first PDN connection is disconnected in the MME-initiated disconnection procedure. Note that the MME 30 may notify the UE 10 of information indicating that the PDN connection is to be reestablished in the MME-initiated disconnection procedure.

First, the MME 30 performs a PDN disconnection trigger detection process (S1006). Here, the PDN disconnection trigger detection process is to determine to perform the MME-initiated disconnection procedure. The PDN disconnection trigger detection process has already been described in the description of the PDN connection change detection process, and hence a detailed description thereof is omitted.

The MME 30 may transmit a service reject to the UE 10 on the basis of the PDN disconnection trigger detection process (S1302). Here, the service reject may be a negative response to the service request transmitted by the UE 10. The service reject may be a message indicating that the service request is rejected.

Note that the MME 30 may include, in the service reject, information indicating that no effective EPS bearer context is present.

Here, the UE 10 may receive the service reject from the MME 30 and detect that the first PDN connection is to be disconnected. Upon detecting that the first PDN connection is to be disconnected, the UE 10 may delete the information on the first PDN connection.

The MME 30 may include information indicating that the PDN connection is to be reestablished in a service reject message, and transmit the message to the UE 10. The UE 10 may receive the service reject message, and perform the UE-initiated PDN connectivity procedure to establish the second PDN connection, in response to the reception of the service reject message and/or on the basis of the information indicating that the PDN connection is to be reestablished.

Further, when disconnecting the first PDN connection, the UE 10 may initiate the UE-initiated PDN connectivity procedure which is described later (S1324). The UE 10 may establish the second PDN connection with APN1 in accordance with the UE-initiated PDN connectivity procedure.

Here, a tracking area update reject may be a negative response to the tracking area update request transmitted by the UE 10.

In other words, the MME 30 may transmit the tracking area update reject to the UE 10 on the basis of the PDN disconnection trigger detection process (S1302). Here, the tracking area update reject may be a negative response to the service request transmitted by the UE 10.

The MME 30 may include, in the tracking area update reject, information indicating that no effective EPS bearer context is present. Here, the UE 10 may receive the tracking area update reject from the MME 30 and detect that the first PDN connection is to be disconnected. Upon detecting that the first PDN connection is to be disconnected, the UE 10 may delete the information on the first PDN connection.

The MME 30 may include information indicating that the PDN connection is to be reestablished in the tracking area update reject message, and transmit the message to the UE 10. The UE 10 may receive the tracking area update reject message, and perform the UE-initiated PDN connectivity procedure to establish the second PDN connection, in response to the reception of the tracking area update reject message and/or on the basis of the information indicating that the PDN connection is to be reestablished.

Further, when disconnecting the first PDN connection, the UE 10 may initiate the UE-initiated PDN connectivity procedure which is described later (S1324). The UE 10 may establish the second PDN connection in accordance with the UE-initiated PDN connectivity procedure.

The MME 30 may transmit a session deletion request to the SGW 50 on the basis of the PDN disconnection trigger detection process (S1304). The MME 30 may include information (EPS bearer ID, LBI, or the like) identifying the EPS bearer. Identification information identifying the first PDN connection which is the subject of the PDN connection to be changed may be included in the information identifying the EPS bearer.

The SGW 50 receives the session deletion request and detects the identification information identifying the first PDN connection included in the session deletion request. The SGW 50 detects that the first PDN connection is to be deleted.

The SGW 50 transmits a session deletion request to the LGW 40 (S1306). Here, the SGW 50 may include information (EPS bearer ID, LBI, or the like) identifying the EPS bearer.

The LGW 40 receives the session deletion request and detects the identification information identifying the first PDN connection included in the session deletion request. The LGW 40 detects that the first PDN connection is to be deleted.

Upon receiving the session deletion request, the LGW 40 may perform a PDN context release process. Here, the PDN context release process is to delete the information on the PDN connection in the LGW 40.

Next, the LGW 40 transmits a session deletion response to the SGW 50 (S1308). Here, the LGW 40 may include information identifying the first PDN connection in the session deletion response.

The SGW 50 may receive the session deletion response from the LGW 40 and delete the information on the first PDN connection managed in the SGW 50.

Upon deleting the information on the first PDN connection, the SGW 50 transmits a session deletion response to the MME 30 (S1310). Here, the SGW 50 may include information identifying the first PDN connection in the session deletion response.

The MME 30 receives the session deletion response from the SGW 50. The MME 30 may detect information identifying the first PDN connection included in the session deletion response. The MME 30 detects that the first PDN connection has been deleted in the LGW 40 and the SGW 50 by detecting the information identifying the first PDN connection.

Here, the MME 30 may receive the session deletion response and delete the information on the first PDN connection.

The MME 30 may detect that the first PDN connection is to be deleted by detecting the PDN disconnection trigger detection process (S1006).

On the other hand, when having not transmitted the service reject to the UE 10 (S1304), the MME 30 may transmit a deactivate bearer request to the eNB 20B (S1312). Here, the MME 30 may include identification information identifying the first PDN connection to be disconnected. For example, the EPS bearer ID may be included.

The MME 30 may include a reactivation value in the deactivate bearer request. The MME 30 may indicate, with the included reactivation value, to the UE 10 that the first PDN connection is to be deleted and the second PDN connection is to be established. In this manner, the MME 30 may include information indicating that the PDN connection is to be reestablished in a deactivate bearer request message, and transmit the message to the eNB 20B.

Here, the deactivate bearer request to be transmitted may be addressed to both the eNB 20B and the UE 10. The deactivate bearer request may be transmitted using different messages. For example, the MME 30 may transmit the deactivate bearer request addressed to the eNB 20B using an S1-AP message and transmit the deactivate bearer request addressed to the UE 10 using a NAS message. Note that the S1-AP message is a message format prescribed for transmitting and receiving control information between the MME 30 and the eNB 20B. The NAS message is a message format prescribed for transmitting and receiving control information between the UE 10 and the MME 30.

When the radio resource has been allocated to the UE 10, such as when the radio bearer has been established between the UE 10 and the eNB 20B, the eNB 20B may determine to release the radio bearer in response to the reception of the deactivate bearer request. More specifically, the eNB 20B may receive the deactivate bearer request and determine to release the radio bearer established with the UE 10, with reference to the identification information identifying the first PDN connection included in the deactivate bearer request.

The radio bearer release procedure will be described below.

In order to release the radio bearer in the first PDN connection, the eNB 20B transmits an RRC connection reconfiguration (S1314). Here, the eNB 20B may include a deactivate bearer request addressed to the UE in the RRC connection reconfiguration.

In this manner, the eNB 20B may include information indicating that the PDN connection is to be reestablished in the RRC connection reconfiguration, and transmit the RRC connection reconfiguration to the UE 10. Note that the eNB 20B may transmit, to the UE 10, information transmitted by the MME 30 indicating that the PDN connection is to be reestablished. The UE 10 may receive the RRC connection reconfiguration and/or deactivate bearer request, and on the basis of the RRC connection reconfiguration and/or the deactivate bearer request and/or the information indicating that the PDN connection is to be reestablished, performs the UE-initiated PDN connectivity procedure to establish the second PDN connection.

The UE 10 receives the RRC connection reconfiguration from the eNB 20B. The UE 10 releases the radio bearer in response to the RRC connection reconfiguration from the eNB 20B. The UE 10 may detect the deactivate bearer request included in the RRC connection reconfiguration. Upon receiving the deactivate bearer request, the UE 10 may delete the first PDN connection. In this case, the UE 10 may delete the information on the first PDN connection.

Furthermore, the UE 10 may detect the reactivation value included in the deactivate bearer request, and detect not only the deletion of the first PDN connection but also the establishment of the second PDN connection.

Upon releasing the radio bearer, the UE 10 transmits an RRC connection reconfiguration complete as a response to the RRC connection reconfiguration (S1316).

The UE 10 transmits the direct transfer to the eNB 20B (S1320). Here, the UE 10 may include a deactivate EPS bearer context accept in the direct transfer.

The eNB 20B receives the direct transfer and transfers the deactivate EPS bearer context accept to the MME 30 (S1322).

Note that when the UE 10 does not transmit the RRC connection reconfiguration complete (S1316) or the direct transfer (S1320), the eNB 20B need not transmit the deactivate bearer response (S1318) and the deactivate EPS bearer context accept (S1322).

When the eNB 20B does not transmit the RRC connection reconfiguration (S1314) to the UE 10, the UE 10 need not transmit the RRC connection reconfiguration complete (S1316) or the direct transfer (S1320).

When the MME 30 does not transmit the deactivate bearer request (S1312), the eNB 20B need not transmit the RRC connection reconfiguration (S1314) to the UE 10.

Through the above-described steps, the radio bearer release procedure is completed.

Through the above-described procedures, the UE 10 can release the first PDN connection and delete the information on the first PDN connection. The eNB 20B can release the first PDN connection and delete the information on the first PDN connection. The MME 30 can release the first PDN connection and delete the information on the first PDN connection.

### 1.3.2.2.2 UE-Initiated PDN Connectivity Procedure

Upon detection that a new PDN connection is to be established as the PDN connection is disconnected, the UE 10 may initiate the UE-initiated PDN connectivity procedure. The UE 10 can establish the second PDN connection by the UE-initiated PDN connectivity procedure.

Note that the UE 10 may determine to perform the UE-initiated PDN connectivity procedure with reference to the reactivation value included in the deactivate bearer request. In other words, the determination may be made not only by the deletion of the first PDN connection but also by the establishment of the second PDN connection.

The UE 10 may detect the needs to delete the first PDN connection and to establish the second PDN connection, and determine to perform the UE-initiated PDN connectivity procedure.

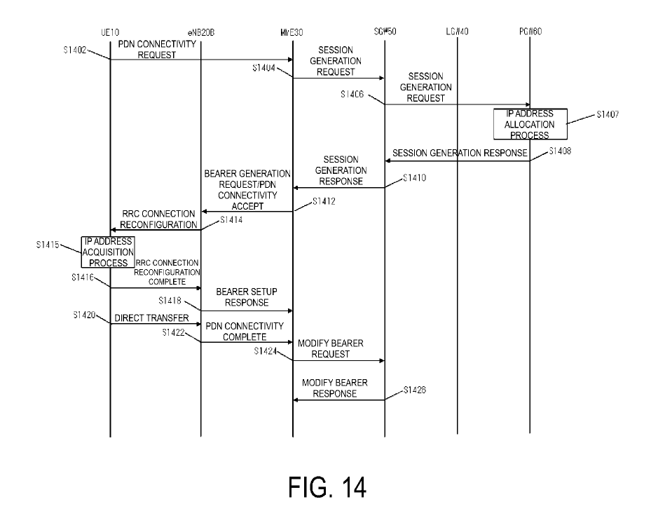

The UE-initiated PDN connectivity procedure will be described with reference to FIG. 14. First, the UE 10 transmits a PDN connectivity request to the MME 30 (S1402).

The UE 10 may include the APN and the PDN type which is included when the first PDN connection is established, in the PDN connectivity request, and transmit the PDN connectivity request.

Here, the example in which the UE 10 requests the establishment of the second PDN connection with the APN used for establishing the first PDN connection has been described, however, the UE 10 may request the establishment of the second PDN connection with a different APN.

For example, the UE 10 may request the establishment of the second PDN connection with APN1 to establish the PDN connection that is a PDN connection for SIPTO and is not permitted to switch to a PDN connection using a different gateway as an end point node.

The UE 10 may request the establishment of the second PDN connection with APN2 to establish the PDN connection that is a PDN connection for SIPTO and is permitted to switch to a PDN connection using a different gateway as an end point node.

Note that the PDN connectivity request transmitted by the UE 10 is transmitted via the eNB 20B. Here, the eNB 20B may include identification information on a neighboring gateway managed by the eNB 20B, such as the LGW 40, in the PDN connectivity request to be transmitted to the MME 30. The eNB 20B may include the LHN ID indicating the network of the LGW 40 in the PDN connectivity request to be transmitted to the MME 30B.

Here, when the eNB 20B does not manage the LGW 40, the eNB 20B need not include the identification information on the neighboring gateway. When not managing the LGW 40, the eNB 20B need not include the LHN ID indicating the network of the LGW 40 in the PDN connectivity request.

The eNB 20B may notify the MME 30 of such information in advance, instead of using the PDN connectivity request.

For example, the eNB 20B may notify the MME 30B of the LHN ID with the LHN ID included in an initial UE message or an uplink NAS transport message, separate from the PDN connectivity request message. The eNB 20B may notify the MME 30 of the information identifying the neighboring gateway, such as the LGW address of the LGW 40B, with the information included in the initial UE message or the uplink NAS transport message, separate from the PDN connectivity request message.

The MME 30 receives the PDN connectivity request from the UE 10 or the eNB 20. The MME 30 may perform GW selection for establishing the PDN connection in accordance with the APN included in the PDN connectivity request. Here, the GW selection is to select a gateway device serving as an endpoint node of the second PDN connection to be established by the UE 10.

Note that the MME 30 selects the gateway serving as the end point node of the second PDN connection in response to the reception of the PDN connectivity request.

Here, the MME 30 selects the PGW 60. Note that the MME 30 may detect that no gateway is present in the vicinity of the eNB 20B and then select the PGW 60.

The MME 30 may query the HSS 70 to select the gateway. The MME 30 may transmit the APN to the HSS 70 and receive the identification information on the PGW 60.

Next, the MME 30 transmits a session generation request to the SGW 40 (S1404). Here, the MME 30 may select in advance the SGW 40 to which the session generation request is transmitted by an SGW selection function. In the SGW selection function, the location information on the UE may be used for the selection of the SGW 50. Further, in order to select the SGW 50, an operator policy defined by the mobile network operator may be used.

The MME 30 may include a PGW address, an APN, a PDN type, and an EPS bearer ID in the session generation request.

Here, the PDN GW address may be identification information on the gateway selected by the MME 30 in the GW selection. Specifically, the PDN GW address may include the identification information identifying the LGW 40 and the identification information identifying the PGW 60. Here, the PGW 60 is selected and the PDN GW address includes the identification information identifying the PGW 60.

Description will be given by assuming that the MME 30 includes APN2 as the APN. Note that APN2 may indicate that a new PDN connection is to be established that is a PDN connection for SIPTO and uses a more optimal gateway.

The MME 30 may determine the PDN type on the basis of information on contract with the user of the UE 10, or the like. The MME 30 may authenticate the PDN type included in the attach request transmitted from the UE 10 to determine the PDN type.

The EPS bearer ID may be bearer identification information allocated to the UE 10 by the MME 30. Note that the EPS bearer ID may be identification information identifying the default bearer.

The SGW 50 transmits a session generation request to the PGW 60 (S1406). Here, the SGW 50 may determine the PGW 60 to which the session generation request is transmitted on the basis of the identification information on the PDN GW address included in the session generation request transmitted from the MME 30 to the SGW 50. The SGW 50 may include an APN, an SGW address (U-plane), an SGW TEID (U-plane), an SGW TEID (C-plane), a PDN type, and an EPS bearer ID in the session generation request.

For the APN, the PDN type, and the EPS bearer ID, the APN, the PDN type, the PDN address, and the EPS bearer ID included in the session generation request transmitted from the MME 30 may be used, respectively.

The SGW address (U-plane), the SGW TEID (U-plane), and the SGW TEID (C-plane) may be information managed in the SGW 50 in advance.

Upon receiving the session generation request, the PGW 60 performs an IP address allocation process (S1407). Here, when the PGW 60 causes a third server device (using DHCP or stateless address configuration) to allocate an IP address, the third server device may provide information indicating the allocation.

The PGW 60 may perform the session establishment procedure. Here, in the session establishment procedure, the PGW 60 may establish a communication path with the default QoS, or may establish a communication path with the EPS bearer QoS different from the default QoS.

The PGW 60 transmits a session generation response to the SGW 50 (S1408). The LGW 40 may include a PGW address (U-plane), a PGW TEID (U-plane), a PGW TEID (C-plane), a PDN type, a PDN address, an EPS bearer ID, and an EPS bearer QoS in the session generation response.

The PGW address (U-plane), the PGW TEID (U-plane), and the PGW TEID (C-plane) may be information managed in the PGW 60 in advance. Here, the PGW address (U-plane) may be identification information identifying the PGW 60. Each of the PGW TEID (U-plane) and the PGW TEID (C-plane) may be the PGW ID. The PGW ID is identification information on the tunnel communication path in the PGW 60.

The PDN type may be the PDN type included in the session generation request (S1408) transmitted from the SGW 50.

The PDN address may be the IP address allocated to the UE 10 by the PGW 60. Here, when the allocation of the IP address is performed by the third server device, the third server device may include information indicating the allocation.

The EPS bearer ID and the EPS bearer QoS may be information elements relating to a case of establishing QoS different from the default bearer.

Further, the SGW 50 transmits a session generation response to the MME 30 (S1410). Here, the SGW 50 may include a PDN type, a PDN address, an SGW address (U-plane), an SGW TEID (U-plane), an SGW TEID (C-plane), an EPS bearer ID, an EPS bearer QoS, a PGW address (U-plane), and a PGW TEID in the session generation response.

Here, the PDN type, the PDN address, the EPS bearer ID, the EPS bearer QoS, the PGW address (U-plane), and the PGW TEID may be information elements included in the session generation request (S1408) transmitted from the PGW 60.

The SGW address (U-plane), the SGW TEID (U-plane), and the SGW TEID (C-plane) may be information elements managed by the SGW 50.

The MME 30 receives the session generation response. The MME 30 may manage the PDN type, the PDN address, the SGW address (U-plane), the SGW TEID (U-plane), the SGW TEID (C-plane), the EPS bearer ID, the EPS bearer QoS, the PGW address (U-plane), and the PGW TEID included in the session generation response, together with the APN and the SIPTO permission information.

The MME 30 can manage information elements managed for each effective PDN connection after movement of the UE in the MME communication path context 342 illustrated in FIG. 7 and information elements managed for each EPS bearer in the PDN connection.

As described above, the MME 30 can manage information on the second PDN connection.

Next, the MME 30 transmits a bearer setup request/PDN connectivity accept to the eNB 20B (S1412). Note that, the MME 30 provides information on the newly established second PDN connection, by including the information in the bearer setup request/PDN connectivity accept.

The bearer generation request may include the EPS bearer QoS, the PDN connectivity accept, the SGW TEID (U-plane), and the SGW address (U-plane). The PDN connectivity accept may include the APN, the PDN type, the PDN address, and the EPS bearer ID.

The eNB 20B receives the bearer setup request/PDN connectivity accept. The eNB 20B determines establishment of a radio bearer with the UE 10 on the basis of the EPS bearer ID and the EPS bearer QoS included in the bearer setup request. Here, the eNB 20A may determine the E-RAB ID on the basis of the EPS bearer ID and the EPS bearer QoS.

The eNB 20A may manage the SGW TEID (U-plane) and the SGW address (U-plane) included in the modify bearer request.

As described above, the eNB 20B can manage the information elements in the eNB communication path context 242, illustrated in (b) after movement in FIG. 5.

Next, the eNB 20B transmits an RRC connection reconfiguration to the UE 10 (S1414). Note that, the eNB 20B includes the PDN connectivity accept in the RRC connection reconfiguration to the UE 10. Here, the eNB 20B may include the PDN connectivity accept to the UE 10, separate from the RRC connection reconfiguration notification. In other words, the eNB 20B transfers the PDN connectivity accept to provide the information on the newly established second PDN connection.

The UE 10 receives the RRC connection reconfiguration and the PDN connectivity accept from the eNB 20B. Here, the UE 10 detects information on the newly established second PDN connection included in the PDN connectivity accept from the eNB 20B, and manages the information in the UE 10.

Note that the information on the second PDN connection may be the APN, the PDN type, the PDN address, the EPS bearer ID, and the EPS bearer QoS.

Next, the UE 10 performs an IP address acquisition process (S1415). Here, the UE 10 may acquire the PDN address included in the PDN connectivity accept as the IP address.

When the PDN address included in the PDN connectivity accept includes information indicating acquisition of an IP address in accordance with DHCP, the UE 10 may acquire the IP address from the DHCP server. Here, the DHCP server may be an external server different from the core network 7, or may be the PGW 60.

When the PDN address included in the PDN connectivity accept includes information indicating acquisition of an IP address in accordance with the stateless address auto-configuration, the UE 10 may receive a router advertisement (RA) from a router device and acquire the IP address on the basis of the router advertisement. Here, the router device may be an external server different from the core network 7, or may be the PGW 60.

The UE 10 acquires the IP address by the above method and manages the IP address as the second PDN connection therein. The UE 10 can manage the information on the second PDN connection in the UE communication path context 142 illustrated in (b) after movement in FIG. 3, and can transmit the uplink data in the second PDN connection.

The UE 10 transmits an RRC connection reconfiguration complete to the eNB 20B (S1416). The eNB 20B receives the RRC connection reconfiguration complete as a response to the RRC connection reconfiguration (S1414), and transmits a bearer setup response to the MME 30 (S1418).

The UE 10 transmits direct transfer to the eNB 20B (S1420). Here, PDN connectivity complete may be included in the direct transfer. The EPS bearer ID may be included in the PDN connectivity complete.

The eNB 20B receives the direct transfer from the UE 10 and transfers the PDN connectivity complete included in the direct transfer to the MME 30 (S1422). Upon receiving the bearer setup response and the PDN connectivity complete, the MME 30 transmits a modify bearer request to the SGW 50 (S1424).

Further, in response to the reception of the modify bearer request, the SGW 50 transmits a modify bearer request to the PGW 60 (S1426).

The PGW 60 receives the modify bearer request and transmits a modify bearer response to the SGW 50 as a response to the modify bearer request (S1428).

Further, the SGW 50 transmits a modify bearer response to the MME 30 as a response to the modify bearer request transmitted from the MME 30 (S1430).

The above-described procedure allows the UE 10 and the PGW 60 to establish the second PDN connection between the UE 10 and the PGW 60. In other words, the UE 10 can manage, as information on the second PDN connection, the APN, the allocated PDN type, the IP address, the default bearer, the EPS bearer ID, and the EPS bearer QoS, in the UE communication path context 142 illustrated in (b) before movement in FIG. 3.

The eNB 20B can manage, as information on the second PDN connection, the MME UE S1 AP ID, the GUMMEI, the global eNB ID, the tracking area ID, the E-RAB ID, the UE ID, and the transport address, in the eNB communication path context 242 illustrated in FIG. 5.

Further, the MME 30 can manage, as information on the second PDN connection, the APN, the PDN type, the IP address, the permission (information) of SIPTO, the PDN GW address (C-plane), the PDN GW TEID (C-plane), the default bearer, the EPS bearer ID, the SGW IP address (S1-u), the SGW TEID (S1-u), the PGW IP address (U-plane), the PGW TEID (U-plane), and the EPS bearer QoS, in the MME communication path context 342 illustrated in FIG. 7.

As described above, the UE 10 can transmit and receive data via the PGW 60 using the second PDN connection.

Note that, when the UE 10 includes APN1 in the attach request (S1402) as an APN and completes the attach procedure to establish the second PDN connection, the UE 10 manages APN1 as the APN, PDN type 1 as the allocated PDN type, IP address 3 as the IP address, EPS bearer ID 3 as the default bearer, EPS bearer ID 7 as the EPS bearer ID, and EPS bearer QoS 3 as the EPS bearer QoS, as illustrated in the UE communication path context 142 in pattern 1, of (b) after movement in FIG. 3.

In this case, the eNB 20 manages MME UE S1 AP ID 1 as the MME UE S1 AP ID, GUMMEI 1 as the GUMMEI, global eNB ID 2 as the global eNB ID, tracking area ID 1 as the tracking area ID, E-RAB ID 2 as the E-RAB ID, UE ID 1 as the UE ID, and SGW TEID 1 and SGW IP address 1 as the transport address, as illustrated in the eNB communication path context 242 in FIG. 5.

The MME 30 manages APN1 as the APN, PDN type 1 as the PDN type, IP address 3 as the IP address, permission of SIPTO and SIPTO@LN as the permission of SIPTO, a blank as the LHN ID, PGW address 1 as the PDN GW address (C-plane), PGW TEID 1 as the PDN GW TEID (C-plane), EPS bearer ID 3 as the default bearer, EPS bearer ID 7 as the EPS bearer ID, PGW IP address 1 as the PGW IP address (U-plane), PGW TEID 1 as the PGW TEID (U-plane), and EPS bearer QoS 2 as the EPS bearer QoS, as indicated in the MME communication path context 342 in pattern 1, (b) after the movement in FIG. 7.

### 1.3.2.3 PDN Connection Change Procedure

A case in which the MME 30 has not detected that the first PDN connection is effective in the modify bearer detection process (S1006) and has determined to change the PDN connection will be described. Note that, in the PDN connection change procedure, the UE 10 does not delete the first PDN connection and maintains the first PDN connection before and after the PDN connection change procedure. Therefore, the UE 10 continues data transmission and reception using the first PDN connection before and after the PDN connection change procedure.

Note that in the PDN connection change procedure, the session in the core network 7 is changed. In other words, the bearer in the core network 7 established in association with the first PDN connection is changed.

More specifically, in the PDN connection change procedure, the session between the SGW 50 and the LGW 40 is deleted, and a new session between the SGW 50 and the PGW 60 is established, thereby changing the session. More specifically, in the PDN connection change procedure, the bearer established between the SGW 50 and the LGW 40 is deleted, and a new bearer between the SGW 50 and the PGW 60 is established, thereby changing the bearer.

Alternatively, when direct connectivity, such as an establishment of a bearer between the eNB 20 and the LGW 40, has been established, the session between the eNB 20 and the LGW 40 is deleted and a session between the eNB 20 and the SGW 50 and a session between the SGW 50 and the PGW 60 are newly established in the PDN connection change procedure, thereby changing the session. More specifically, the bearer between the eNB 20 and the LGW 40 is deleted, and a bearer between the eNB 20 and the SGW 50, and a bearer between the SGW 50 and the PGW 60 are newly established, thereby changing the bearer.

In this manner, communication control for optimally changing bearers configured in association with the first PDN connection is performed in the modify bearer procedure. In that case, the gateway serving as the end point node of the first PDN connection may be changed from the LGW 40 to the PGW 60. Note that in the modify bearer procedure, the IP address acquired by the UE 10 may be changed.

More specifically, in the PDN connection change procedure, the delete session procedure between the LGW and the SGW and the create session procedure may be performed.

### 1.3.2.3.1 Delete Session Procedure Between LGW and SGW

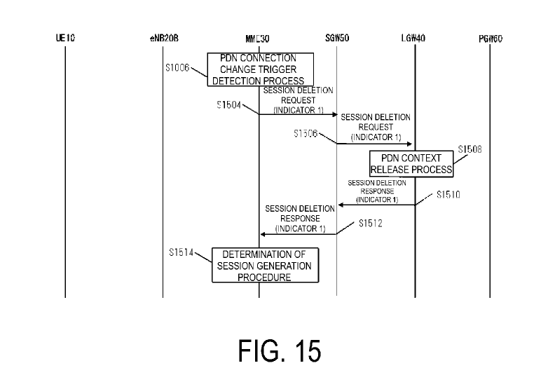

The delete session procedure between the LGW and the SGW will be described with reference to FIG. 15. In the delete session procedure between the LGW and the SGW, the LGW 40 which is not the optimal gateway in the first PDN connection and the bearer to the LGW 40 are deleted.

First, the MME 30 performs a PDN connection change trigger detection process (S1006). The PDN connection change trigger detection process is to determine to perform the PDN connection change procedure. The PDN connection change trigger detection process has already been described in the PDN connection change detection process, and hence detailed description thereof will be omitted.

Upon determining to perform the PDN connection change procedure, the MME 30 transmits a session deletion request to the SGW 50 (S1504). Here, the MME 30 may include indicator 1 in the session deletion request. The MME 30 may include information (EPS bearer ID, LBI, or the like) identifying the EPS bearer. Identification information identifying the first PDN connection which is the subject of the PDN connection to be changed may be included in the information identifying the EPS bearer.

Indicator 1 may be information indicating that the PDN connection is to be changed rather than that the PDN connection is to be deleted.

The SGW 50 receives the session deletion request and detects the identification information identifying the first PDN connection included in the session deletion request. The SGW 50 detects that the first PDN connection is to be deleted.

The SGW 50 may detect indicator 1 included in the session deletion request. The SGW 50 may detect that the first PDN connection is to be changed, rather than that the first PDN connection is to be deleted, by detecting the identification information identifying the first PDN connection and indicator 1.

The SGW 50 transmits a session deletion request to the LGW 40 (S1506). Here, the SGW 50 may include information (EPS bearer ID, LBI, or the like) identifying the EPS bearer. The SGW 50 may include indicator 1 in the session deletion request.

The LGW 40 receives the session deletion request and detects the identification information identifying the first PDN connection included in the session deletion request. The LGW 40 detects that the first PDN connection is to be deleted.

The LGW 40 may detect indicator 1 included in the session deletion request. The LGW 40 may detect that the first PDN connection is to be changed, rather than that the first PDN connection is to be deleted, by detecting the identification information identifying the first PDN connection and indicator 1.

Upon receiving the session deletion request, the LGW 40 performs a PDN context release process (S1508). Here, the PDN context release process is to delete the information on the PDN connection in the LGW 40.

Upon completion of the PDN context release process, the LGW 40 transmits a session deletion response to the SGW 50 (S1510). Here, the LGW 40 may include information identifying the first PDN connection in the session deletion response. The LGW 40 may include indicator 1 in the session deletion response.

The SGW 50 may receive the session deletion response from the LGW 40 and delete the information on the first PDN connection managed in the SGW 50.

Upon deleting the information on the first PDN connection, the SGW 50 transmits a session deletion response to the MME 30 (S1512). Here, the SGW 50 may include information identifying the first PDN connection in the session deletion response. The SGW 50 may include indicator 1 in the session deletion response.

The MME 30 receives the session deletion response from the SGW 50. The MME 30 may detect information identifying the first PDN connection included in the session deletion response. The MME 30 detects that the first PDN connection has been deleted in at least the LGW 40 by detecting the information identifying the first PDN connection.

Here, the MME 30 may receive the session deletion response and delete the identification information identifying the LGW 40 in the first PDN connection. The identification information identifying the LGW 40 is the correlation ID or the LGW IP address.

The MME 30 may detect that the first PDN connection has been deleted in the SGW 40.

The MME 30 may detect indicator 1 included in the session deletion response. The MME 30 may detect that the first PDN connection is to be changed rather than that the first PDN connection is to be deleted, by detecting indicator 1.

The MME 30 may detect that the first PDN connection is to be changed rather than that the first PDN connection is to be deleted, by detecting the PDN connection change trigger detection process (S1502).

The MME 30 may determine to perform the create session procedure (S1514). The determination to perform the create session procedure may be made by the MME 30 on the basis of indicator 1 included in the session deletion response. The MME 30 may determine to change the PDN connection in the PDN connection change trigger detection process (S1502) and the determination may be made by the MME 30.

### 1.3.2.3.2.1 Create Session Procedure 1

Next, create session procedure 1 in the MME 30 will be described. In delete session procedure 1 between the LGW and the SGW, the LGW 40 that is not the optimal gateway in the first PDN connection and the bearer to LGW 40 are deleted. In create session procedure 1, however, a bearer between the eNB 20 and the SGW 50, and a bearer between the SGW 50 and PGW 60 are established in the first PDN connection.

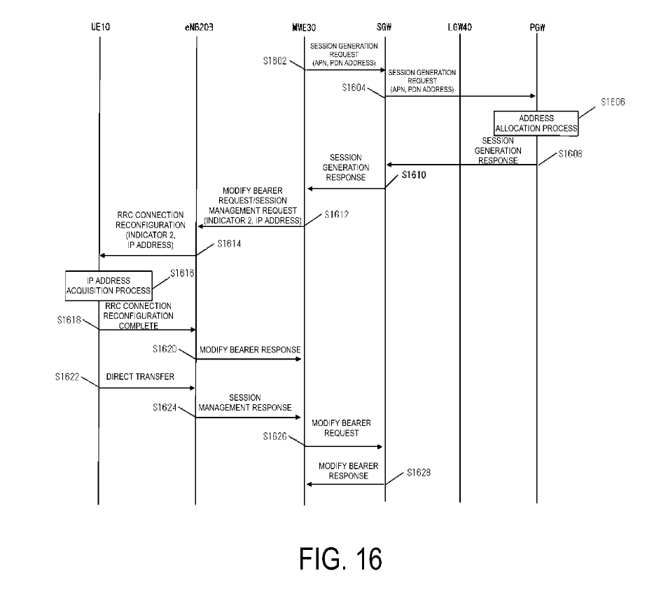

Create session procedure 1 will be described with reference to FIG. 16. The MME 30 transmits a session generation request to the SGW 50 (S1602). Here, the MME 30 may select the SGW 40 in advance using an SGW selection function. In the SGW selection function, the location information on the UE may be used for selection of the SGW 50. Further, in order to select the SGW 50, an operator policy defined by the mobile network operator may be used. Here, although the SGW 50 is selected, another SGW may be selected. In the present embodiment, description will be given by assuming that the SGW 50 is selected.

The MME 30 may include identification information identifying the APN included in the MME communication path context 342 in the session generation request. Here, description will be given by assuming that the MME 30 includes APN2 as the APN.

The MME 30 may indicate that a new PDN connection that is a PDN connection for SIPTO and uses a more optimal gateway is to be established by including APN2.

The MME 30 may include a PGW address, an APN, a PDN type, and an EPS bearer ID in the session generation request.

Here, the PDN GW address may be identification information on the gateway selected by the MME 30 using the GW selection function. Here, the MME 30 may query the HSS 70 to select the gateway. The MME 30 may transmit the APN and the location information to the HSS 70 and receive the identification information on the PGW 60.

Specifically, the PDN GW address may include the identification information identifying the LGW 40 and the identification information identifying the PGW 60. Here, the PGW 60 is selected and the PDN GW address includes the identification information identifying the PGW 60.

The PDN type may be a PDN type in which the MME 30 is included in the MME communication path context 342. The PDN type may be determined on the basis of information on contract with the user of the UE 10, or the like.

The EPS bearer ID may be an EPS bearer ID in which the MME 30 is included in the MME communication path context 342. The EPS bearer ID may be bearer identification information allocated to the UE 10.

The MME 30 may include the PDN address included in the MME communication path context 342 in the session generation request. The identification information indicating, by including the PDN address, the need to reacquire the IP address may be included. The IP address allocated to the UE 10 may be designated to the PGW 60 by including the PDN address. With this step, the MME 30 may designate the IP address used by the UE 10 before the session switch procedure such that the UE 10 continues communication without changing the IP address before or after the session switch procedure.

Alternatively, the MME 30 may include identification information requesting an allocation of an IP address in the session generation request. The MME 30 may request the PGW 60 to allocate a new IP address to the UE 10 by including the identification information requesting the allocation of the IP address. Alternatively, the MME 30 may request the PGW 60 to allocate a new IP address to the UE 10 by not including the identification information requesting the allocation of the IP address and/or the PDN address in the session generation request.

The MME 30 may include identification information identifying the PGW 60 in the session generation request. Here, the MME 30 may perform the GW selection. The GW selection causes a gateway device serving as an end point node of the first PDN connection to be selected. The MME 30 selects the PGW 60 by the GW selection.

Note that when no LGW is located in the vicinity of the eNB 20B, the MME 30 may select the PGW 60 included in the core network. Therefore, when being capable of detecting the LGW located in the vicinity of the eNB 20B, the MME 30 may select the detected LGW. Furthermore, the LGW may be a local gateway different from the LGW 40.

Here, the process when the MME 30 selects a local gateway different from the LGW 40 may be a process and/or a procedure in which the PGW 60 is replaced by the local gateway in the process in which the PGW 60 is selected. Therefore, detailed description of the process will be omitted. Next, the SGW 50 transmits a session generation request to the PGW 60 (S1604). Here, the SGW 50 may determine the PGW 60 to which the session generation request is transmitted on the basis of the identification information on the PDN GW address included in the session generation request transmitted from the MME 30 to the SGW 50. The SGW 50 may include an APN, an SOW address (U-plane), an SGW TEID (U-plane), an SGW TEID (C-plane), a PDN type, and an EPS bearer ID in the session generation request.

The APN, the PDN type, and the EPS bearer ID may use the APN, the PDN type, and the EPS bearer ID included in the session generation request transmitted from the MME 30, respectively.

The SGW address (U-plane), the SGW TEID (U-plane), and the SGW TEID (C-plane) may be information managed in the SGW 50 in advance.

Further, when the received session generation request includes identification information requesting the allocation of the PDN address and/or the IP address, the SGW 50 may transmit the session generation request to the PGW 60 together with the identification information requesting the allocation of the PDN address and/or the IP address.

Next, the PGW 60 receives the session generation request. The PGW 60 may perform the IP address allocation process in response to the reception of the session generation request (S1606).

Here, when the PGW 60 acquires the PDN address included in the session generation request, the PGW 60 may allocate the PDN address to the UE 10.

When acquiring the identification information requesting the IP address allocation included in the session generation request, the PGW 60 may newly allocate an IP address to the UE 10.

Alternatively, when the MME 30 requests the PGW 60 to newly allocate an IP address to the UE 10 by not including the identification information requesting the IP address allocation and/or the PDN address in the session generation request, the PGW 60 may newly allocate an IP address to the UE 10.

Specifically, the PGW 60 may newly allocate an IP address in accordance with a procedure using DHCP or the stateless address.

Here, when the PGW 60 causes a third server device (using DHCP or stateless address configuration) to allocate an IP address, the third server device, such as a DHCP server in an external network different from the core network, may provide information indicating the allocation.

The PGW 60 may perform the session establishment procedure. Here, in the session establishment procedure, the PGW 60 may establish a communication path with the default QoS, or may establish a communication path with the EPS bearer QoS different from the default QoS.

The PGW 60 transmits a session generation response to the SGW 50 (S1608). The PGW 60 may include a PGW address (U-plane), a PGW TEID (U-plane), a PGW TEID (C-plane), a PDN type, a PDN address, an EPS bearer ID, and an EPS bearer QoS in the session generation response.

The PGW address (U-plane), the PGW TEID (U-plane), and the PGW TEID (C-plane) may be information managed in the PGW 60 in advance. Here, the PGW address (U-plane) may be identification information identifying the PGW 60.

The PDN type may be the PDN type included in the session generation request (S1604) transmitted from the SGW 50.

The PDN address may be the IP address allocated to the UE 10 by the PGW 60. Here, when the allocation of the IP address is performed by the third server device, the third server device may include information indicating the allocation. The PDN address may be a PDN address in the session generation request transmitted from the SGW 50.

The EPS bearer ID and the EPS bearer QoS may be information elements relating to a case of establishing QoS different from the default bearer.

Further, the SGW 50 transmits a session generation response to the MME 30 (S1610). Here, the SGW 50 may include a PDN type, a PDN address, an SGW address (U-plane), an SGW TEID (U-plane), an SGW TEID (C-plane), an EPS bearer ID, an EPS bearer QoS, a PGW address (U-plane), and a PGW TEID in the session generation response.

Here, the PDN type, the PDN address, the EPS bearer ID, the EPS bearer QoS, the PGW address (U-plane), and the PGW TEID may be information elements included in the session generation request (S1608) transmitted from the PGW 60.

The SGW address (U-plane), the SGW TEID (U-plane), and the SGW TEID (C-plane) may be information elements managed in the SGW 50.

The MME 30 receives the session generation response. The MME 30 may manage the PDN type, the PDN address, the SGW address (U-plane), the SGW TEID (U-plane), the SGW TEID (C-plane), the EPS bearer ID, the EPS bearer QoS, the PGW address (U-plane), and the PGW TEID included in the session generation response, together with the APN, the SIPTO permission information, and the LHN ID.

The MME 30 can manage information elements managed for each effective PDN connection after movement of the UE in the MME communication path context 342 illustrated in FIG. 7 and information elements managed for each EPS bearer in the PDN connection.

In other words, in the MME communication path context 342, the MME 30 changes the IP address from IP address 2 to IP address 4; changes the LHN ID from LHN ID 1 to a blank; changes the PDN GW address (C-plane) from LGW address 1 to PGW address 1; changes the PDN GW TEID from correlation ID 1 to PGW TEID 1; changes the SGW IP address (S1-u) from a blank to SGW IP address 1; changes the SGW TEID (S1-u) from a blank to SGW TEID 1; changes the PGW IP address (U-plane) from LGW IP address 1 to PGW IP address 1; and change the PGW TEID (U-plane) from correlation ID 1 to PGW TEID 1. As described above, the MME 30 can update information on the first PDN connection. Note that in the above description, the MME 30 changes the IP address from IP address 2 to IP address 4, however, when the IP address is not received from the SGW 50 and/or when IP address 2 is received as the IP address from the SGW 50, the IP address does not have to be changed.

Next, the MME 30 transmits a modify bearer request/session management request to the eNB 20B (S1612). Here, the MME 30 may include information on the EPS bearer and information on the IP address in the session management request. The information on the EPS bearer is information on the EPS bearer ID and the EPS bearer QoS. The information on the IP address may be the IP address and the PDN type.

Note that when an IP address is newly allocated by the PGW 60, the MME 30 may transmit the information on the IP address with the information included in the session management request in response to the change of the IP address.

The session management request may include indicator 2. Indicator 2 may be information indicating that the first PDN connection is to be changed. Here, the information indicating that the first PDN connection is to be changed may include an APN. Additionally, or alternatively, indicator 2 may be information notifying that the IP address of the first PDN connection is to be changed. Additionally, or alternatively, indicator 2 may be information requesting that the IP address of the first PDN connection is to be reacquired.

Note that when the MME 30 does not include information on the IP address in the session management request, the MME 30 may transmit indicator 2 with indicator 2 included in the session management request. Additionally, or alternatively, when an IP address is newly allocated by the PGW 60, the MME 30 may transmit indicator 2 with indicator 2 included in the session management request.

The MME 30 may include the EPS bearer ID and the EPS bearer QoS in the modify bearer request. Furthermore, the MME 30 may include an SGW TEID and SGW IP address 1 in the modify bearer request.

The eNB 20B receives the modify bearer request/session management request. The eNB 20B determines to change the radio bearer with the UE 10 on the basis of the EPS bearer ID and the EPS bearer QoS included in the modify bearer request. Here, the eNB 20B may change the E-RAB ID on the basis of the EPS bearer ID and the EPS bearer QoS.

The eNB 20B may change, on the basis of the SGW TEID and SGW IP address 1 included in the modify bearer request, the transport addresses from correlation ID 1 and the LGW IP address to the SGW TEID and SGW IP address 1, respectively.

As described above, the eNB 20B can manage the information elements in the eNB communication path context 242, illustrated in (b) after movement in FIG. 5.

Next, the eNB 20B transmits an RRC connection reconfiguration to the UE 10. Note that the eNB 20B may transmit a session management request to the UE 10 with the session management request included in the RRC connection reconfiguration notification. Here, the eNB 20 may include the session management request, separate from the RRC connection reconfiguration notification to the UE 10. In other words, the eNB 20B transfers the session management request to provide information on the first PDN connection to be changed.

The eNB 20B may include information on the EPS bearer and information on the IP address in the session management request and/or the RRC connection reconfiguration notification. The information on the EPS bearer is information on the EPS bearer ID and the EPS bearer QoS. The information on the IP address may be the IP address and the PDN type.

Note that when an IP address is newly allocated by the PGW 60 and/or an IP address to be newly allocated to the UE 10 is included in the session management request and/or the RRC connection reconfiguration notification which are transmitted by the MME 30, the eNB 20B may transmit, in response to the change in the IP address, the information on the IP address with the information included in the session management request and/or the RRC connection reconfiguration notification.

The session management request and/or the RRC connection reconfiguration notification may include indicator 2. Indicator 2 may be information indicating that the first PDN connection is to be changed. Here, the information indicating that the first PDN connection is to be changed may include an APN. Additionally, or alternatively, indicator 2 may be information indicating that the IP address of the first PDN connection is to be changed. Additionally, or alternatively, indicator 2 may be information requesting that the IP address of the first PDN connection is to be reacquired.

Note that when the eNB 20B does not include the information on the IP address in the session management request and/or the RRC connection reconfiguration notification, the eNB 20B may transmit indicator 2 with indicator 2 included in the session management request and/or the RRC connection reconfiguration notification. Additionally, or alternatively, when an IP address is newly allocated by the PGW 60, the MME 30 may transmit indicator 2 with indicator 2 included in the session management request and/or the RRC connection reconfiguration notification. Additionally, or alternatively, when the MME 30 transmits indicator 2 with indicator 2 included in the session management request and/or the RRC connection reconfiguration notification, received indicator 2 may be transmitted included in the session management request and/or the RRC connection reconfiguration notification. The UE 10 receives the RRC connection reconfiguration and/or the session management request from the eNB 20B.

The UE 10 may detect information on the first PDN connection included in the RRC connection reconfiguration and/or the session management request transmitted from the eNB 20B and change the information on the first PDN connection in the UE 10.

Here, the information on the first PDN connection may be included in indicator 2. Note that the information on the first PDN connection may be the PDN type, the PDN address, the EPS bearer ID, and the EPS bearer QoS.

Next, the UE 10 may update the IP address used for the communication using the first PDN connection in response to the reception of the RRC connection reconfiguration and/or the session management request.

Upon receiving the IP address included in the RRC connection configuration and/or the session management request, the UE 10 may update the IP address stored in the UE communication path context 142 in association with the first PDN connection to the received IP address. Further, the UE 10 may initiate transmission and reception of the user data using the first PDN connection with the received IP address (S1616).

When receiving indicator 2 included in the session management request and/or the RRC connection reconfiguration notification, the UE 10 may perform an IP address acquisition process.

A more specific IP address acquisition process may be an acquisition procedure in accordance with DHCP. The UE 10 may transmit a DHCP discover message and/or a DHCP request message to the DHCP server and receive the IP address and/or IP prefix with the response from the DHCP server. Note that the IP address to be received may be an IPv4 address or an IPv6 address. When receiving a 64-bit IP prefix, the UE 10 may generate lower 64 bits with the received IP prefix set as upper bits, which results in an IPv6 address.

Note that the DHCP server may be an external server configured outside the core network 7 or may be the PGW 60.

The specific IP address acquisition process may be performed in accordance with the stateless address auto-configuration procedure. The UE 10 may transmit a router solicitation message (RS) to the default router to receive a router advertisement (RA).

The UE 10 may receive a router advertisement including the IP address and/or the IP prefix from the default router. When receiving a 64-bit IP prefix, the UE 10 may generate lower 64 bits with the received IP prefix set as upper bits, which results in an IPv6 address.

Note that the default router may be the SGW 50 or the PGW 60.

The UE 10 may determine whether the UE 10 performs the acquisition procedure in accordance with DHCP or the acquisition procedure in accordance with the stateless address auto-configuration procedure, in accordance with the received session management request and/or RRC connection reconfiguration notification. For example, when information indicating an acquisition of an IP address in accordance with DHCP is included in the IP address included in the session management request and/or the RRC connection reconfiguration notification, the UE 10 performs the acquisition procedure in accordance with DHCP, and when the PDN address included in the session management request and/or the RRC connection reconfiguration notification includes information indicating that an IP address is acquired in accordance with the stateless address auto-configuration, the UE 10 performs the acquisition procedure in accordance with the stateless address auto-configuration procedure.

Note that when the IP address or indicator 2 is not acquired in response to the reception of the RRC connection reconfiguration and/or session management request, the UE 10 may continue to use the IP address corresponding to the first PDN connection without deleting the IP address. According to the above method, the UE 10 can communicate using the first PDN connection, by the use of the information associated with the first PDN connection of the UE communication path context 142.

However, when changing the IP address, the UE 10 updates the information on the IP address in (a) of FIG. 3. Note that the UE 10 may continue to use items as they are, other than the IP address. However, when the eNB 20 has transmitted a new EPS bearer ID with the ID included in the RRC connection reconfiguration, the EPS bearer ID associated with the first PDN connection is updated to the received EPS bearer ID.

The UE 10 transmits an RRC connection reconfiguration complete (S1618). The eNB 20B receives the RRC connection reconfiguration complete as a response to the RRC connection reconfiguration (S1614), and transmits a modify bearer response to the MME 30 (S1620).

The UE 10 transmits direct transfer to the eNB 20B (S1622). Here, the direct transfer may include a session management response. The session management response may include the EPS bearer ID.

The eNB 20B receives the direct transfer from the UE 10 and transfers the session management response included in the direct transfer to the MME 30 (S1624). Upon receiving the modify bearer response and the session management response, the MME 30 transmits a modify bearer request to the SGW 50 (S1626). The SGW 50 receives the modify bearer request from the MME 30 and transmits a modify bearer response to the MME 30 (S1628).

The above-described procedure allows the session of the first PDN connection between the UE 10 and the PGW 60 to be changed. From the procedure, the UE 10 can manage, as information on the first PDN connection, the APN, the allocated PDN type, the IP address, the default bearer, the EPS bearer ID, and the EPS bearer QoS, in the UE communication path context 142 illustrated in (a) of FIG. 3.

The eNB 20B can manage, as information on the first PDN connection, the MME UE S1 AP ID, the GUMMEI, the global eNB ID, the tracking area ID, the E-RAB ID, the UE ID, and the transport address, in the eNB communication path context 242 illustrated in FIG. 5.

Further, the MME 30 can manage, as information on the first PDN connection, the APN, the PDN type, the IP address, the permission (information) of SIPTO, the LHN ID, the PDN GW address (C-plane), the PDN GW TEID (C-plane), the default bearer, the EPS bearer ID, the SGW IP address (S1-u), the SGW TEID (S1-u), the PGW IP address (U-plane), the PGW TEID (U-plane), and the EPS bearer QoS, in the MME communication path context 342 illustrated in FIG. 7.

As described above, the UE 10 can change a part of the sessions and/or part of the bearers of the first PDN connection, and can transmit and receive data via the PGW 60.

In other words, in accordance with the service request procedure, the communication path of the first PDN connection can be changed from the LGW 40 that is a gateway device to the PGW 60 that is a gateway device different from the LGW 40, and communication using the first PDN connection can be performed.

Note that after the completion of the above-described procedures, the UE 10 can manage APN2 as the APN, PDN type 2 as the allocated PDN type, IP address 4 as the IP address, EPS bearer ID 2 as the default bearer, EPS bearer ID 6 as the EPS bearer ID, and EPS bearer QoS 2 as the EPS bearer QoS, as illustrated in the UE communication path context 142 in pattern 2 (b) after movement of FIG. 3.

In this case, the eNB 20B can manage MME UE S1 AP ID 1 as the MME UE S1 AP ID, GUMMEI 1 as the GUMMEI, global eNB ID 2, tracking area ID 1 as the tracking area ID, E-RAB ID 2 as the E-RAB ID, UE ID 1 as the UE ID, and SGW TEID 1 and SGW IP address 1 as the transport address, as illustrated in the eNB communication path context 242 in (b) after movement in FIG. 5.

The MME 30 can manage APN2 as the APN, PDN type 2 as the PDN type, IP address 4 as the IP address, permission of CSIPTO as the permission of SIPTO, a blank as the LHN ID, PGW address 1 as the PDN GW address (C-plane), PGW TEID 1 as the PDN GW TEID (C-plane), EPS bearer ID 2 as the default bearer, EPS bearer ID 6 as the EPS bearer ID, PGW IP address 1 as the PGW IP address (U-plane), PGW TEID 1 as the PGW TEID (U-plane), and EPS bearer QoS 2 as the EPS bearer QoS, as illustrated in the MME communication path context 342 in pattern 2 (b) after the movement in FIG. 7.

The above-described procedure allows the UE 10 to perform communication using the first PDN connection after the switch procedure. The switch procedure changes the gateway device which serves as an end point node of the first PDN connection. Further, the procedure changes the bearer of the first PDN connection. Accordingly, the UE 10 may change the IP address for performing communication using the first PDN connection.

### 1.3.2.3.2.2 Create Session Procedure 2

Next, create session procedure 2 in the MME 30 will be described. Although transmission and reception of data is initiated in accordance with the service request procedure in create session procedure 1, a bearer between the eNB 20 and the SGW 50 and a bearer between the SGW 50 and the PGW 60 are established in the first PDN connection in accordance with the tracking area request procedure in create session procedure 2.

Create session procedure 2 will be described with reference to FIG. 17. First, the MME 30 transmits a session generation request to the SGW 50 (S1602). Next, the SGW 50 transmits a session generation request to the PGW 60 (S1604). The PGW 60 performs an address allocation process (S1606). The PGW 60 transmits a session generation response to the SGW 50 (S1608). Further, the SGW 50 transmits a session generation response to the MME 30 (S1610). Here, the session generation request (S1602) through the session generation response (S1610) have been described in the description of create session procedure 1, and hence detailed description thereof will be omitted. Here, the session generation request transmitted by the SGW 50 may be a modify bearer request. The session generation request transmitted by the PGW 60 may be a modify bearer response.

Next, the MME 30 may transmit a tracking area update accept to the UE 10. The tracking area update accept may include information indicating the location of the UE. Here, the information indicating the location of the UE may be a tracking area ID.

Here, the MME 30 may include information on the EPS bearer and information on the IP address in the tracking area update request. The information on the EPS bearers is information on the EPS bearer ID and the EPS bearer QoS. The information on the IP address may be the IP address and the PDN type.

Note that when an IP address is newly allocated by the PGW 60, the MME 30 may transmit the information on the IP address with the information included in the session management request in response to the change of the IP address.

The tracking area update request may include indicator 2. Indicator 2 may be information indicating that the first PDN connection is to be changed. Here, the information indicating that the first PDN connection is to be changed may include an APN. Additionally, or alternatively, indicator 2 may be information indicating that the IP address of the first PDN connection is to be changed. Additionally, or alternatively, indicator 2 may be information requesting that the IP address of the first PDN connection is to be reacquired.

Note that when the MME 30 does not include the information on the IP address in the tracking area update request, the MME 30 may transmit indicator 2 with indicator 2 included in the tracking area update request. Additionally, or alternatively, when an IP address is newly allocated by the PGW 60, the MME 30 may transmit indicator 2 with indicator 2 included in the tracking area update request.

The UE 10 may detect the information on the first PDN connection included in the tracking area update request transmitted from the MME 30 and change the information on the first PDN connection in the UE 10.

Here, the information on the first PDN connection may be included in indicator 2. Note that the information on the first PDN connection may be the PDN type, the PDN address, the EPS bearer ID, and the EPS bearer QoS.

Next, the UE 10 may update the IP address used for the communication using the first PDN connection in response to the reception of the tracking area update request.

Upon receiving the IP address included in the tracking area update request, the UE 10 may update the IP address stored in the UE communication path context 142 in association with the first PDN connection to the received IP address.

When receiving indicator 2 included in the tracking area update request, the UE 10 may perform an IP address acquisition process.

A more specific IP address acquisition process may be an acquisition procedure in accordance with DHCP. The UE 10 may transmit a DHCP discover message and/or a DHCP request message to the DHCP server and receive the IP address and/or IP prefix with the response from the DHCP server. Note that the IP address to be received may be an IPv4 address or an IPv6 address. When receiving a 64-bit IP prefix, the UE 10 may generate lower 64 bits with the received IP prefix set as upper bits, which results in an IPv6 address.

Note that the DHCP server may be an external server configured outside the core network 7 or may be the PGW 60.

The specific IP address acquisition process may be performed in accordance with the stateless address auto-configuration procedure. The UE 10 may transmit a router solicitation message (RS) to the default router to receive a router advertisement (RA).

The UE 10 may receive a router advertisement including the IP address and/or the IP prefix from the default router. When receiving a 64-bit IP prefix, the UE 10 may generate lower 64 bits with the received IP prefix set as upper bits, which results in an IPv6 address.

Note that the default router may be the SGW 50 or the PGW 60.

The UE 10 may determine whether the UE 10 performs the acquisition procedure in accordance with DHCP or the acquisition procedure in accordance with the stateless address auto-configuration procedure, in accordance with the received tracking area update request. For example, when information indicating an acquisition of an IP address in accordance with DHCP is included in the IP address included in the tracking area update request, the UE 10 performs the acquisition procedure in accordance with DHCP, and when the PDN address included in the tracking area update request includes information indicating that an IP address is acquired in accordance with the stateless address auto-configuration, the UE 10 performs the acquisition procedure in accordance with the stateless address auto-configuration procedure.

Note that when the IP address or indicator 2 is not acquired in response to the reception of the tracking area update request, the UE 10 may continue to use the IP address corresponding to the first PDN connection without deleting the IP address.

According to the above method, the UE 10 can communicate using the first PDN connection, by the use of the information associated with the first PDN connection of the UE communication path context 142.

However, when changing the IP address, the UE 10 updates the information on the IP address in (a) of FIG. 3. Note that the UE 10 may continue to use items as they are, other than the IP address. However, when the MME 30 has transmitted a new EPS bearer ID with the ID included in the tracking area update request, the EPS bearer ID associated with the first PDN connection is updated to the received EPS bearer ID.

The above-described procedure allows the session of the first PDN connection between the UE 10 and the PGW 60 to be changed. From the procedure, the UE 10 can manage, as information on the first PDN connection, the APN, the allocated PDN type, the IP address, the default bearer, the EPS bearer ID, and the EPS bearer QoS, in the UE communication path context 142 illustrated in (a) of FIG. 3.

The MME 30 can manage, as information on the first PDN connection, the APN, the PDN type, the IP address, the permission (information) of SIPTO, the LHN ID, the PDN GW address (C-plane), the PDN GW TEID (C-plane), the default bearer, the EPS bearer ID, the SGW IP address (S1-u), the SGW TEID (S1-u), the PGW IP address (U-plane), the PGW TEID (U-plane), and the EPS bearer QoS, in the MME communication path context 342 illustrated in FIG. 7.

As described above, the UE 10 can change a part of the sessions and/or part of the bearers of the first PDN connection.

Note that after the completion of the above-described procedures, the UE 10 can manage APN2 as the APN, PDN type 2 as the allocated PDN type, IP address 4 as the IP address, EPS bearer ID 2 as the default bearer, EPS bearer ID 6 as the EPS bearer ID, and EPS bearer QoS 2 as the EPS bearer QoS, as illustrated in the UE communication path context 142 in pattern 2 (b) after movement of FIG. 3.

The MME 30 can manage APN2 as the APN, PDN type 2 as the PDN type, IP address 4 as the IP address, permission of CSIPTO as the permission of SIPTO, a blank as the LHN ID, PGW address 1 as the PDN GW address (C-plane), PGW TEID 1 as the PDN GW TEID (C-plane), EPS bearer ID 2 as the default bearer, EPS bearer ID 6 as the EPS bearer ID, PGW IP address 1 as the PGW IP address (U-plane), PGW TEID 1 as the PGW TEID (U-plane), and EPS bearer QoS 2 as the EPS bearer QoS, as illustrated in the MME communication path context 342 in pattern 2 (b) after the movement of FIG. 7.

The above-described procedure allows the UE 10 to perform communication using the first PDN connection after the switch procedure. The switch procedure changes the gateway device which serves as an end point node of the first PDN connection. Further, the procedure changes the bearer of the first PDN connection. Accordingly, the UE 10 may change the IP address for performing communication using the first PDN connection.

### 2. Modified Example

As described above, the method described in the above embodiments can be applied to the stored information and the process in each of the devices including the UE 10, and hence detailed description thereof is omitted.

The embodiments and multiple modified examples relating to the embodiment have been described above. The modified examples may be individually applied to the embodiments. The embodiments of the invention have been described in detail thus far with reference to the drawings, but the specific configuration is not limited to the embodiments. Other designs and the like that do not depart from the essential spirit of the invention also fall within the scope of the patent claims.

Additionally, the program run on the devices in the embodiments are programs that control a CPU (programs that cause a computer to function) so as to realize the functions of the above-described embodiment. The information handled by these devices is temporarily held in a transitory storage device (RAM, for example) at the time of processing, and is then stored in various storage devices such as a ROM and an HDD, read out by the CPU as necessary, and edited and written.

Here, a semiconductor medium (a ROM, a non-volatile memory card, or the like, for example), an optical recording medium/magneto-optical recording medium (a digital versatile disc (DVD), a magneto optical disc (MO), a mini disc (MD), a compact disc (CD), a BD, or the like, for example), a magnetic recording medium (magnetic tape, a flexible disk, or the like, for example), and the like can be given as examples of recording media for storing the programs. In addition to realizing the functions of the above-described embodiments by executing programs that have been loaded, there are also cases where the functions of the present invention are realized by the programs running cooperatively with an operating system, other application programs, or the like on the basis of instructions included in those programs.

When delivering these programs to market, the programs can be stored in a portable recording medium, or transferred to a server computer connected via a network such as the Internet. In this case, the storage device serving as the server computer is of course also included in the present invention.

Additionally, each device in the above-described embodiment may be partially or completely realized as a large scale integration (LSI) circuit, which is a typical integrated circuit. The functional blocks of each device may be individually realized as chips, or may be partially or completely integrated into a chip. The circuit integration technique is not limited to LSI, and the integrated circuits for the functional blocks may be realized as dedicated circuits or a general-purpose processor. Furthermore, if advances in semiconductor technology produce circuit integration technology capable of replacing LSI, it is of course possible to use integrated circuits based on the technology.

### REFERENCE SIGNS LIST

1 Mobile communication system
5 IP mobile communication network
7 Core network
9 LTE access network
10 UE
20 eNB
30 MME
40 LGW
50 SGW
60 PGW
70 HSS
80 PCRF
90 PDN

1. A terminal device configured to:
establish a first packet data network (PDN) connection with a first gateway device, the first PDN connection being a PDN connection capable of changing a communication path thereof from a communication path to the first gateway device to a communication path to a second gateway device;
initiate a service request procedure by transmitting a service request message to a base station device to make a transition from an idle state to an active state;
change the communication path of the first PDN connection from the communication path to the first gateway device to the communication path to the second gateway device in accordance with the service request procedure; and
perform communication using the first PDN connection.

2. The terminal device according to claim 1, configured to
transmit a first access point name (APN) to a core network to establish the first PDN connection, the first APN being an APN associated with permission information permitting a change of the communication path of the first PDN connection from the communication path to the first gateway device to the communication path to the second gateway device.

3. The terminal device according to claim 2, configured to:
transmit and receive user data through the first PDN connection using a first IP address;
receive a second IP address from the core network in accordance with the service request procedure;
change the first IP address to the second IP address; and
transmit and receive the user data through the first PDN connection using the second IP address.

4. The terminal device according to claim 2, configured to:
transmit a second APN to the core network to establish a second PDN connection with the first gateway device, the second APN being an APN different from the first APN and an APN not associated with the permission information permitting a change of a communication path of the second PDN connection from the communication path to the first gateway device to the communication path to the second gateway device;
initiate the service request procedure by transmitting the service request message to the base station device to make a transition from the idle state to the active state;
receive a service reject message, the service reject message being a response to the service request message and rejecting the service request; and
transmit the second APN to the core network to establish a third PDN connection with the second gateway device in response to the reception of the service reject message.

5. The terminal device according to claim 1, wherein
the first gateway device is a local gateway (LGW) located for offloading, and
the second gateway device is a packet data gateway (PGW) located in the core network.

6. A mobility management entity (MME) configured to:
receive, from a base station device, a service request message transmitted by a terminal device to make a transition from an idle state to an active state, and
in a case that the terminal device has established at least a first PDN connection,
initiate a control procedure to change a communication path of the first PDN connection from a communication path to the first gateway device to a communication path to a second gateway device in accordance with the service request procedure, the first PDN connection being a PDN connection capable of changing the communication path thereof from the communication path to the first gateway device to the communication path to the second gateway device.

7. The MME according to claim 6, wherein
the first PDN connection is a PDN connection established using a first access point name (APN), and
the first APN is an APN associated with permission information permitting a change of the communication path of the first PDN connection from the communication path to the first gateway device to the communication path to the second gateway device.

8. The MME according to claim 7, configured to:
in a case that the terminal device has established at least a second PDN connection,
transmit a service reject message in response to the reception of the service request message, the service reject message being a response to the service request message and rejecting the service request; and
request the terminal device to initiate an attach procedure by transmitting the service reject message,
the second PDN connection being a PDN connection established using the second APN, and
the second APN being an APN different from the first APN and an APN not associated with the permission information permitting a change of a communication path of the second PDN connection from the communication path to the first gateway device to the communication path to the second gateway device.

9. The MME according to claim 6, wherein
the first gateway device is a local gateway (LGW) located for offloading, and
the second gateway device is a packet data gateway (PGW) located in the core network.

10. A base station device configured to:
receive, from a terminal device, a service request message transmitted for making a transition from an idle state to an active state;
transmit the service request message to a core network;
receive an IP address to be allocated to the terminal device from the core network; and
notify the terminal device of the IP address.

11. A base station device configured to:
receive, from a terminal device, a service request message transmitted for making a transition from an idle state to an active state;
transmit the service request message to the core network;
receive first identification information from the core network, the first identification information being identification information indicating that the terminal device needs to reacquire an IP address; and
notify the terminal device of the first identification information.

12. A communication control method for a terminal device, the communication control method comprising the steps of:
establishing a first packet data network (PDN) connection with a first gateway device, the first PDN connection being a PDN connection capable of changing a communication path thereof from a communication path to the first gateway device to a communication path to a second gateway device;
initiating a service request procedure by transmitting a service request message to a base station device to make a transition from an idle state to an active state;
changing the communication path of the first PDN connection from the communication path to the first gateway device to the communication path to the second gateway device in accordance with the service request procedure; and
performing communication using the first PDN connection.

13. The communication control method for a terminal device according to claim 12, further comprising the step of:
transmitting a first access point name (APN) to a core network to establish the first PDN connection, the first APN being an APN associated with permission information permitting a change of the communication path of the first PDN connection from the first gateway device to the second gateway device.

14. The communication control method for a terminal device according to claim 13, further comprising the steps of:
transmitting and receiving user data through the first PDN connection using a first IP address;
receiving a second IP address from the core network in accordance with the service request procedure;
changing the first IP address to the second IP address; and
transmitting and receiving the user data through the first PDN connection using the second IP address.

15. The communication control method for a terminal device according to claim 13, further comprising the steps of:
transmitting a second APN to the core network to establish a second PDN connection with the first gateway device, the second APN being an APN different from the first APN and an APN not associated with the permission information permitting a change of a communication path of the second PDN connection from the communication path to the first gateway device to the communication path to the second gateway device;
initiate the service request procedure by transmitting a service request message to the base station device to make a transition from the idle state to the active state;
receiving a service reject message, the service reject message being a response to the service request message and rejecting the service request; and
transmitting the second APN to the core network to establish a third PDN connection with the second gateway device in response to the reception of the service reject message.

16. The communication control method for a terminal device according to any claim 12, wherein
the first gateway device is a local gateway (LGW) located for offloading, and
the second gateway device is a packet data gateway (PGW) located in the core network.

17. A communication control method for a mobility management entity (MME), the communication control method comprising the steps of:
receiving, from a base station device, a service request message transmitted by a terminal device to make a transition from an idle state to an active state; and
in a case that the terminal device has established at least a first PDN connection,
initiating a control procedure to change a communication path of the first PDN connection from a communication path to a first gateway device to a communication path to a second gateway device in accordance with the service request procedure, the first PDN connection being a PDN connection capable of changing the communication path thereof from the communication path to the first gateway device to the communication path to the second gateway device.

18. The communication control method for an MME according to claim 17, wherein
the first PDN connection is a PDN connection established using a first access point name (APN), and
the first APN is an APN associated with permission information permitting a change of the communication path of the first PDN connection from the communication path to the first gateway device to the communication path to the second gateway device.

19. The communication control method for an MME according to claim 18, further comprising the steps of:
in a case that the terminal device has established at least a second PDN connection,
transmitting a service reject message in response to the reception of the service request message, the service reject message being a response to the service request message and rejecting the service request; and
requesting the terminal device to initiate an attach procedure by transmitting the service reject message,
the second PDN connection being a PDN connection established using a second APN, and
the second APN being an APN different from the first APN and an APN not associated with the permission information permitting a change of a communication path of the second PDN connection from the first gateway device to the second gateway device.

20. The communication control method for an MME according to claim 17, wherein
the first gateway device is a local gateway (LGW) located for offloading, and
the second gateway device is a packet data gateway (PGW) located in a core network.

21. A communication control method for a base station device, the communication control method comprising the steps of:
receiving, from a terminal device, a service request message transmitted for making a transition from an idle state to an active state;
transmitting the service request message to a core network;
receiving an IP address to be allocated to the terminal device from the core network; and
notifying the terminal device of the IP address.

22. A communication control method for a base station device, the communication control method comprising the steps of:
receiving, from a terminal device, a service request message transmitted for making a transition from an idle state to an active state;
transmitting the service request message to a core network;
receiving first identification information from the core network, the first identification information being identification information indicating that the terminal device needs to reacquire an IP address; and
notifying the terminal device of the first identification information.
